(19) United States
(12) Patent Application Publication
(10) Pub. No.: US 2024/0248748 A1
(43) Pub. Date: Jul. 25, 2024

(54) METHODS AND SYSTEMS FOR PRIORITIZING IDENTIFICATION OF SUBOPTIMAL RESOURCES IN A DISTRIBUTED COMPUTING ENVIRONMENT

(71) Applicant: VMWARE, INC., Palo Alto, CA (US)

(72) Inventors: CHANDRASHEKHAR JHA, Bangalore (IN); Kameswaran Subramanian, Palo Alto, CA (US); Iwan Rahabok, Suntec City (SG); Varghese Philipose, Dubai (AE); Tigran Matevosyan, Yerevan (AM)

(21) Appl. No.: 18/130,927

(22) Filed: Apr. 5, 2023

(30) Foreign Application Priority Data
Jan. 25, 2023 (IN) 202341005209

(51) Int. Cl. G06F 9/48; G06F 18/2413; G06F 18/2431

(52) U.S. Cl. CPC G06F 9/4818; G06F 18/24147; G06F 18/2431

(57) ABSTRACT

This disclosure is directed to automated computer-implemented methods and systems for prioritizing recommended suboptimal resources of a data center. Methods and system described herein save time and increase the accuracy of identifying actual suboptimal resources and executing remedial measures to correct the suboptimal resources.

### RELATED APPLICATIONS

Benefit is claimed under 35 U.S.C. 119(a)-(d) to Foreign Application Serial No. 202341005209 filed in India entitled “METHODS AND SYSTEMS FOR PRIORITIZING IDENTIFICATION OF SUBOPTIMAL RESOURCES IN A DISTRIBUTED COMPUTING ENVIRONMENT”, on Jan. 25, 2023, by VMware, Inc., which is herein incorporated in its entirety by reference for all purposes.

### TECHNICAL FIELD

This disclosure is directed to methods and systems for accurate identification of suboptimal resources in a data center.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large, distributed computing systems are implemented in data centers and are made possible by advancements in virtualization, computer networking, distributed operating systems and applications, data-storage appliances, computer hardware, and software technologies. The number and size of data centers has grown in recent years to meet the increasing demand for information technology (“IT”) services, such as running applications for organizations that provide business services, web services, streaming services, and other cloud services to millions of users each day.

Advancements in virtualization and software technologies provide many advantages for development and deployment of applications in data centers. Enterprises, governments, and other organizations now conduct commerce, provide services over the internet, and process large volumes of data using distributed applications executed in data centers. A distributed application comprises multiple software components called microservices that are executed in virtual machines (“VMs”), or in containers, on multiple server computers of a data center. These software components communicate and coordinate data processing and data stores to appear as a single coherent application that provides services to end users. Data centers run tens of thousands of these distributed applications in VMs and containers that can be scaled up or down to meet customer and client demands. For example, the number of VMs that provide a microservice can be scaled up to satisfy an increased demand for the service and scaled down when demand for the service decreases, which frees up computing resources. VMs and containers can also be migrated to different host server computers within a data center to optimize use of data center resources.

Organizations that rely on data centers to run their applications cannot afford problems that result in downtime or slow execution of their applications. Such issues frustrate application users, damage a brand name, result in lost revenue, and, in some cases, deny users access to vital services. Data center operations management tools have been developed to aid system administrators with monitoring thousands of dynamically changing data center resources for suboptimal performance and recommend corrective action. Suboptimal resources include idle resources, unused resources, or orphaned resources. The resources include VMs, containers, server computers, disks, and network devices. These operations management tool monitor resource behavior to identify suboptimal resources, display alerts on a system administrator's consoles to notify system administrators of the suboptimal resource, and generate and display recommended remedial measures for resolving the suboptimal resource.

However, a number of the resources identified as suboptimal by typical operations management tools have been mistakenly identified as suboptimal. These mistakenly identified suboptimal resources are called false positive suboptimal resources or simply false positives. Executing remedial measures to correct a false positive only delays correction of actual problems with suboptimal resources and often creates a cascade of unnecessary stoppage or slow performance of an organization's applications, which, in some cases, can unnecessarily cost an organization millions of dollars. As a result, systems administrators cannot always trust that the recommended resources (i.e., resources identified as suboptimal) for remedial measures will not contain false positives. System administrator are faced with not executing the recommended remedial measures or having to decide which of the remedial measures produced should be executed to correct the problem. To avoid executing unnecessary remedial measures on false positives, systems administrators attempt to manually examine each recommended resource, read the numerous recommended remedial measures, and select the appropriate remedial measure in a short period of time. However, such efforts still result in mistakenly executing remedial measures to correct a false positive creating downstream problems. Consider, for example, a VM that is connected to a disk. Suppose the operations management tool has correctly identified the VM as an idle VM and has mistaken identified the disk as unused (i.e., false positive). But systems administrator will have a difficult time deciding on selecting removal of the idle VM because typical operation management tools present the systems administrator with two different recommendations in separate sections of the output: One recommendation is to delete the VM in the VM section of the output. The other recommendation is to disconnect the disk in the disk section of the output. However, if the systems administrator chooses to disconnect the disk when the actual suboptimal resource is the idle VM, disconnection of the disk will create a cascade of problems with other VMs or containers that need access to data stored to the disk. System administrators seek automated processes and systems that accurately identify suboptimal resources in a data center.

### SUMMARY

This disclosure is directed to automated computer-implemented methods and systems for prioritizing recommended suboptimal resources of a data center. Methods and systems classify recommended resources into different classes according to resource parameters of the recommended resources, and construct a priority model for each of the classes. When a request to determine a priority of a resource is received, methods and systems determine the class the resource belongs to and the priority model of the class is used to compute the priority of the resource. The magnitude of the priority of the resource reveals how likely the resource is to being suboptimal. Remedial measures are executed to correct the resource based on the priority. The remedial measures include executing remedial measures includes deleting the resource, restarting the resource, and migrating the resource to a different host.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B show examples of operations manager receiving metrics from physical and virtual objects of the data center.

FIG. 15 shows an example architecture of an operations manager.

FIG. 16 shows an example table of suboptimal resources and benefits obtained by applying remedial measures to correct the suboptimal resources.

FIG. 17A shows an example table of resources and representations of categorical parameters and recommendations of dependent resources.

FIG. 17B an example table of resources and representations of categorical parameters and recommendations of dependent resources.

FIG. 18 shows an example plot of tuples represented as data points in a multi-dimensional space.

FIGS. 19A-19C shows an example of Gaussian clustering.

FIGS. 20A-21B show application of Gaussian clustering to clusters shown in FIG. 19C.

FIG. 22 shows a set of data points clustered into five clusters.

FIG. 23 shows the clusters of FIG. 22 partitioned into training data and validation data.

FIG. 24A shows categorical parameters and encoded categorical variables for a set of training data.

FIG. 24B shows a system of equations formed from resource parameters.

FIG. 24C shows the system of equations in FIG. 24B rewritten in matrix form.

FIG. 25 shows the five clusters of data points and corresponding predictor coefficients.

FIG. 26 shows a control-flow diagram of a method for identifying and correcting suboptimal resources of a data center.

FIG. 27 shows a flow diagram of an example implementation of the “use clustering to classify resources according to similar categorical parameters and encoded categorical variables” called in FIG. 26.

FIG. 28 shows a flow diagram of an example implementation of the “test cluster for Gaussian fit” procedure called in FIG. 27.

FIG. 29 shows a flow diagram of an example implementation of the “use machine learning to construct a priority model for each class of resources” procedure called in FIG. 26.

FIG. 30 shows a flow diagram of an example implementation of the “classify the resource as a belong to one of the predicted classes” procedure called in FIG. 26.

### DETAILED DESCRIPTION

This disclosure presents automated computer-implemented methods and systems for improved identification of suboptimal resources of a data center. In a first subsection, computer hardware, complex computational systems, and virtualization are described. Computer-implemented methods and systems for identification of suboptimal resources of a data center are described below in a second subsection.

### Computer Hardware, Complex Computational Systems, and Virtualization

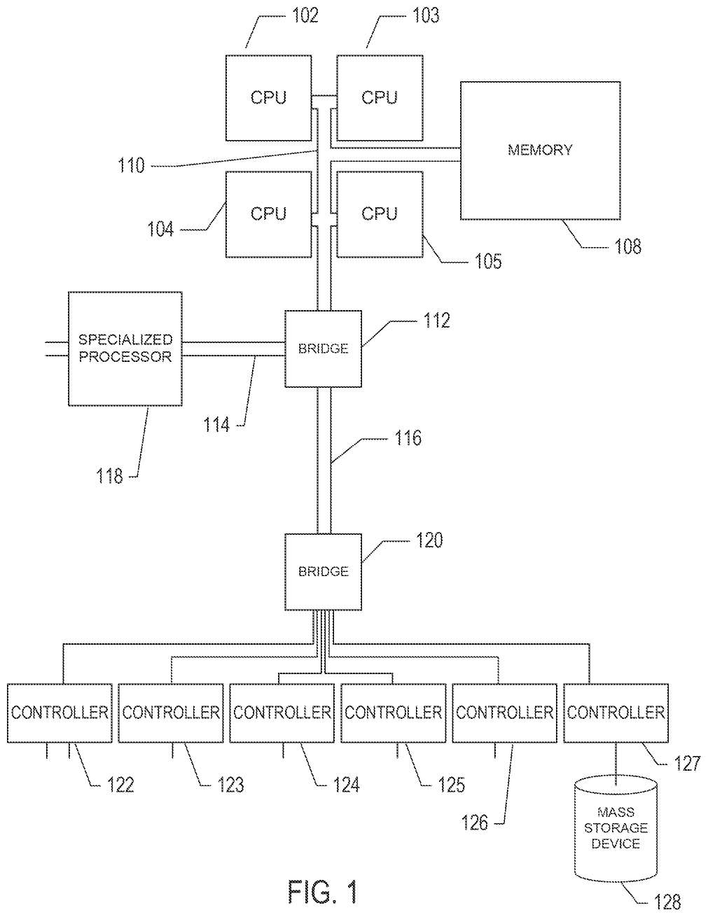

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

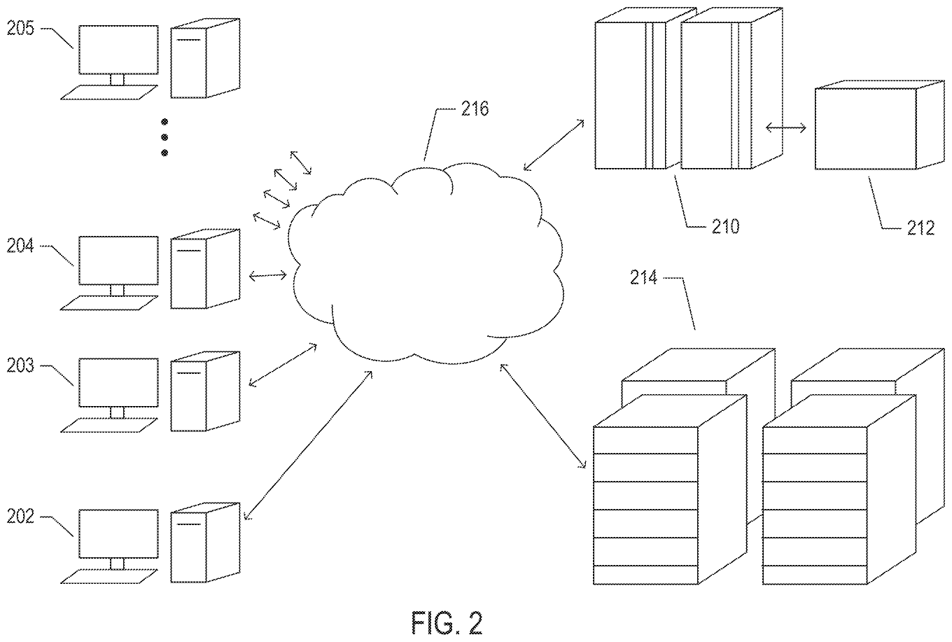

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

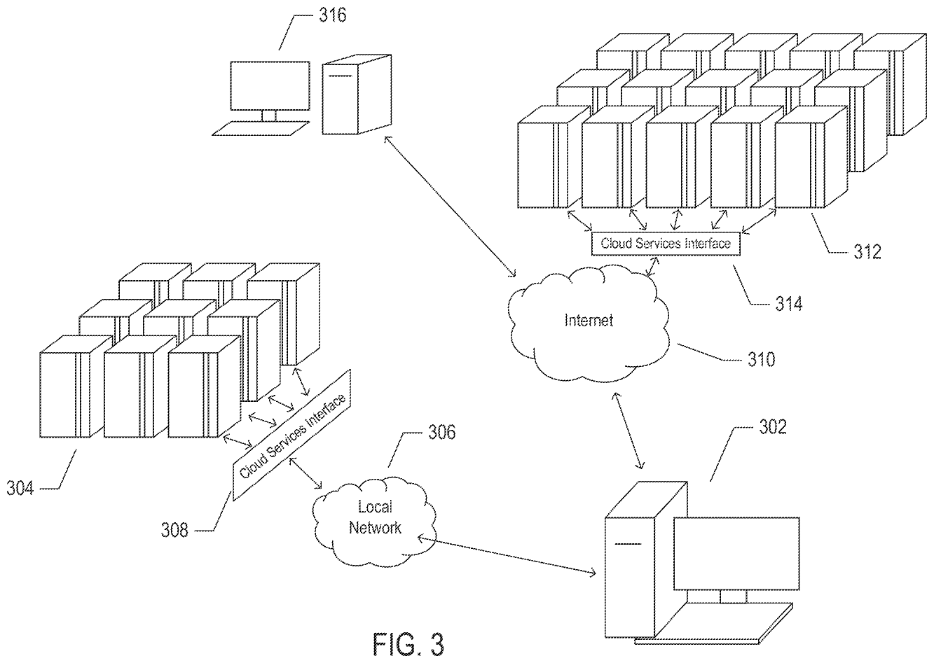

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

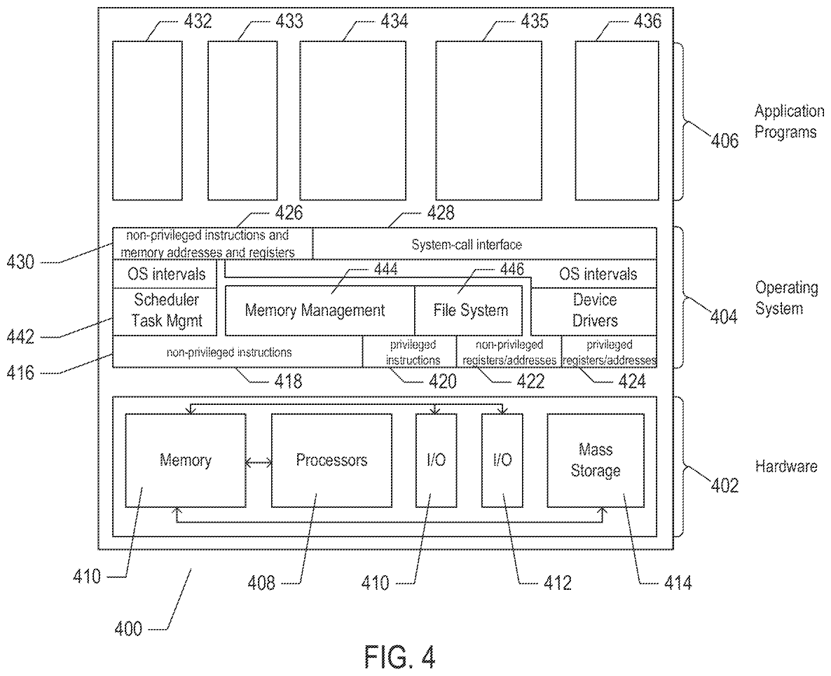

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

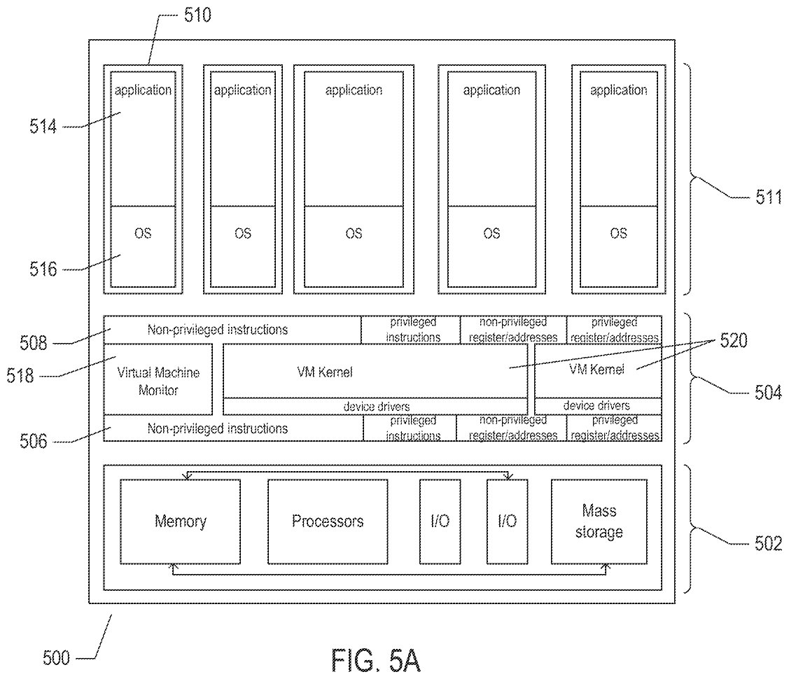

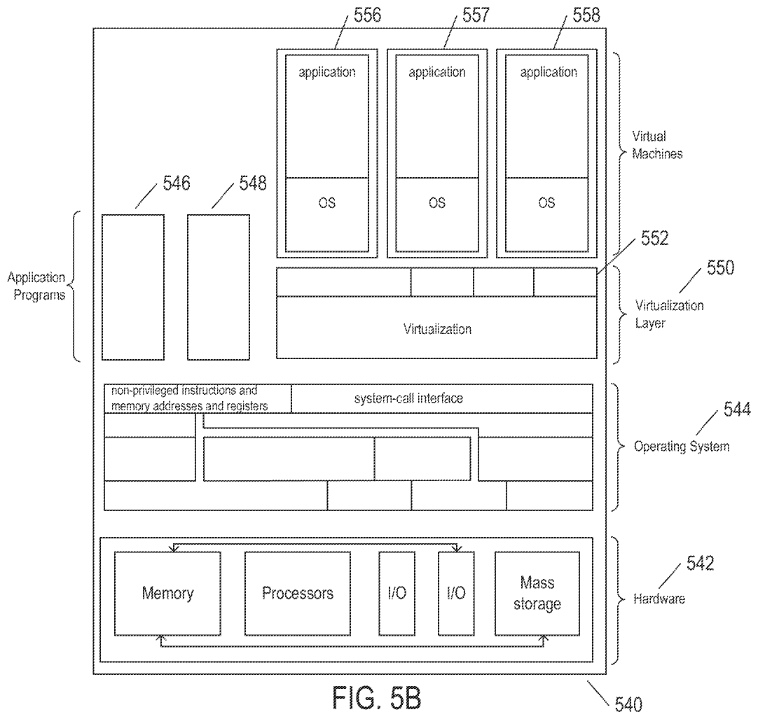

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

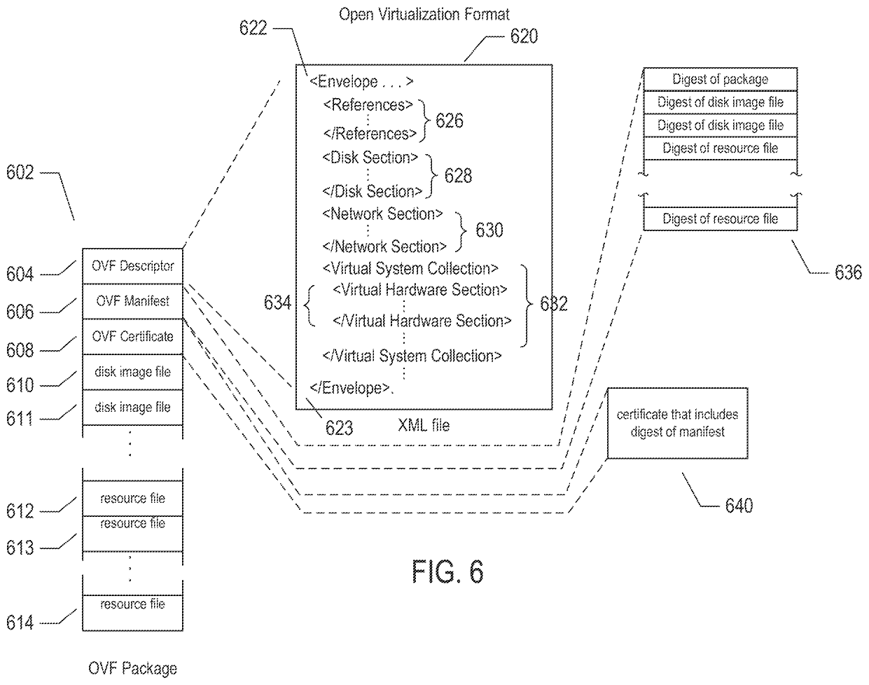

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

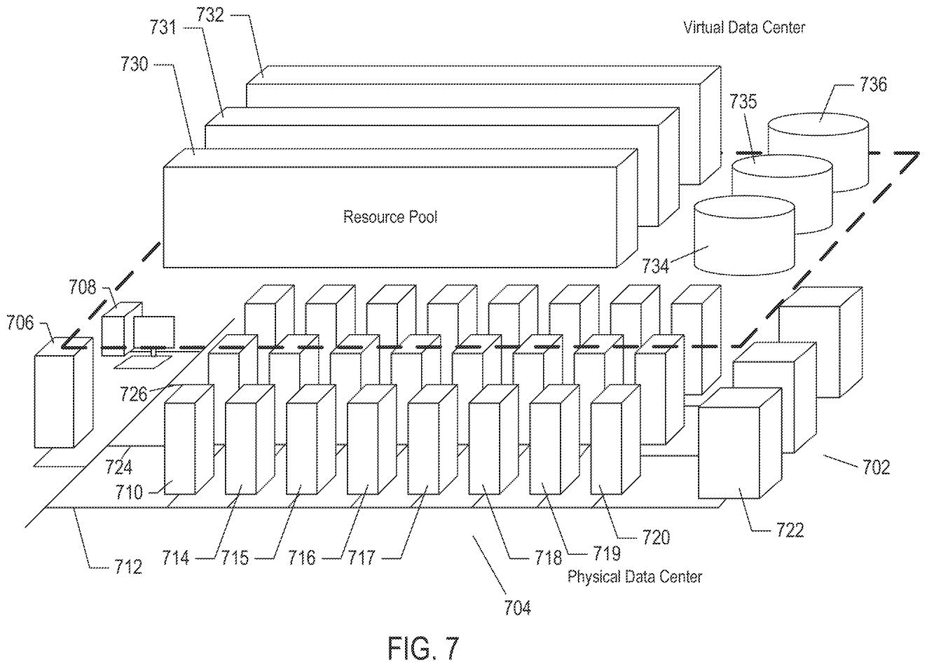

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

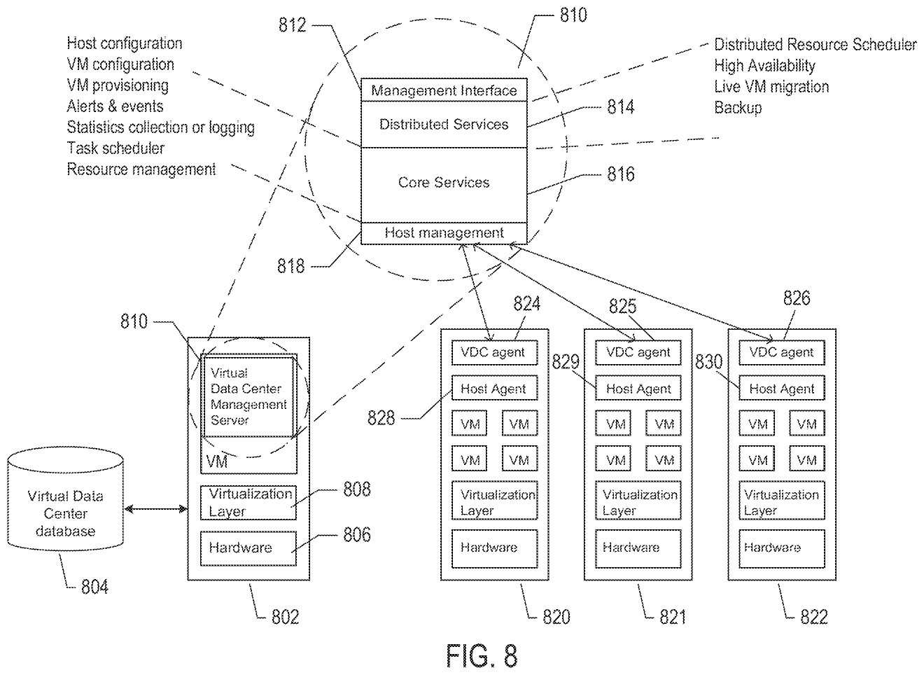

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

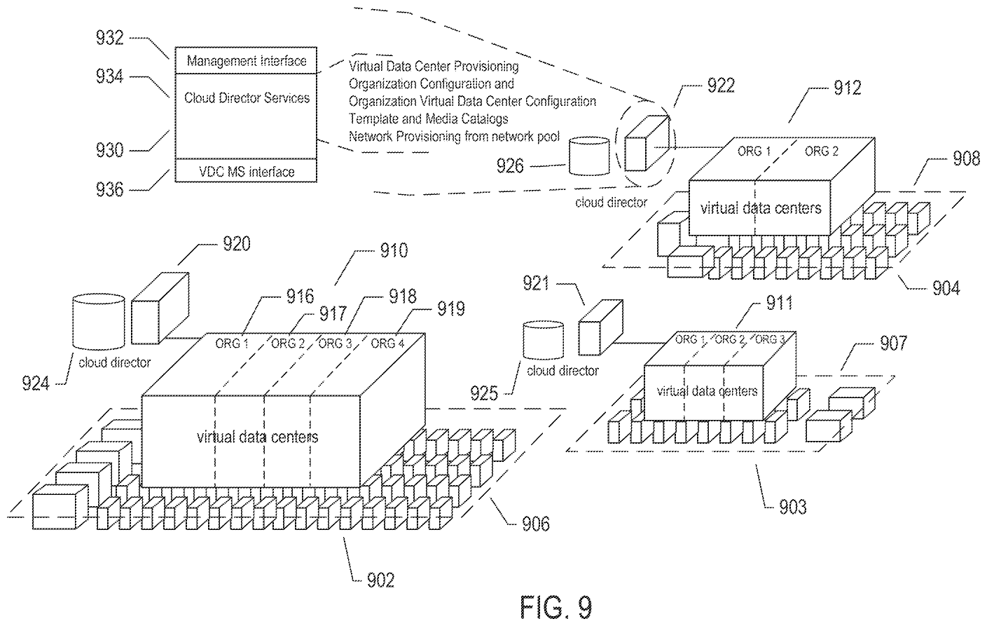

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

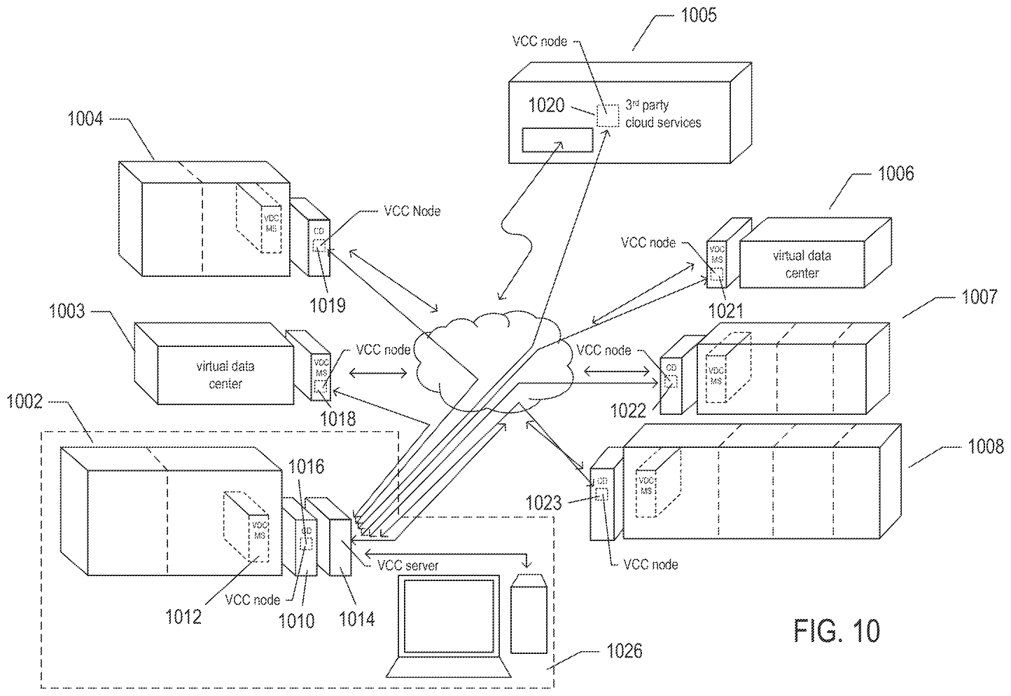

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

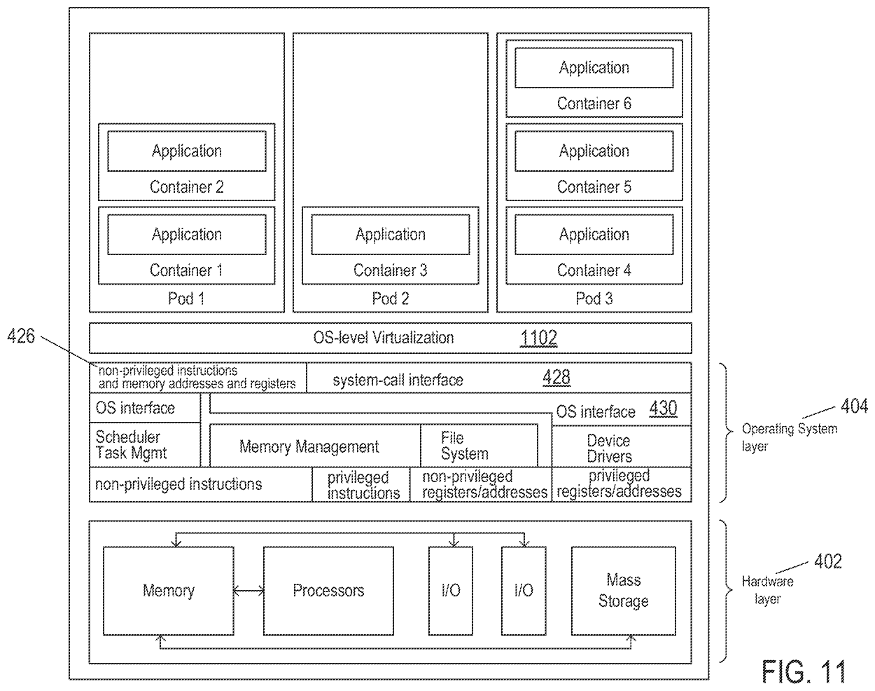

FIG. 11 shows an example server computer used to host three pods. As discussed above with reference to FIG. 4, an operating system layer 404 runs on the hardware layer 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly on the operating system layer 404, OSL virtualization involves an OSL virtualization layer 1102 that provides operating-system interfaces to each of the pods 1-3. In this example, applications are run separately in containers 1-6 that are in turn run in pods identified as Pod 1, Pod 2, and Pod 3. Each pod runs one or more containers with shared storage and network resources, according to a specification for how to run the containers. For example, Pod 1 runs an application 1104 in container 1 and another application 1106 in a container identified as container 2.

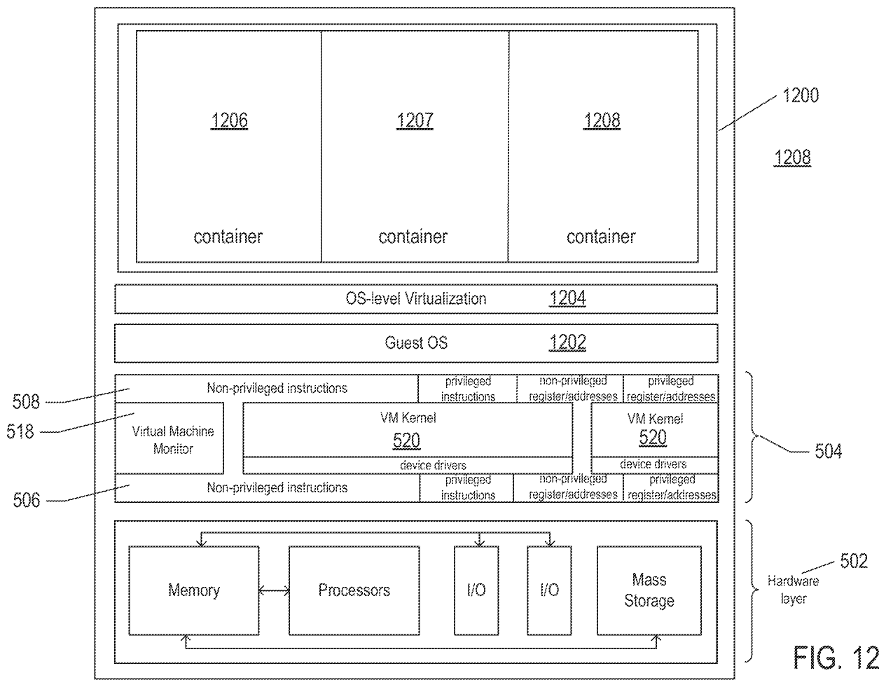

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Computer-implemented Methods and Systems for Identification of Suboptimal Resources of a Data Center

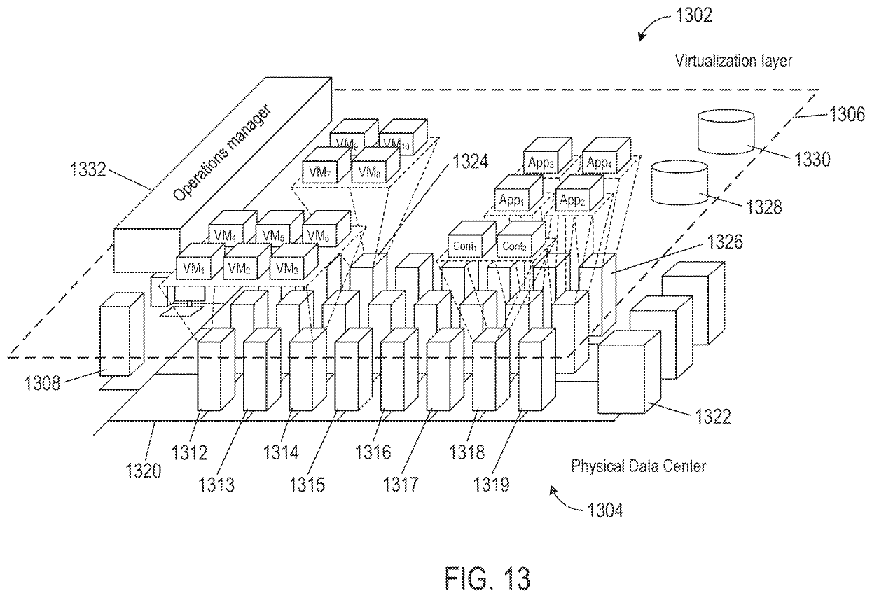

FIG. 13 shows an example of a virtualization layer 1302 located above a physical data center 1304. For the sake of illustration, the virtualization layer 1302 is separated from the data center 1304 by a virtual-interface plane 1306. The data center 1304 is an example of a distributed computing system. The data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects executing in the virtualization layer 1302.

The virtual-interface plane 1306 abstracts the resources of the physical data center 1304 to one or more VDCs comprising the virtual objects and one or more virtual data stores, such as virtual data store 1328. For example, one VDC may comprise the VMs running on server computer 1324 and virtual data store 1328. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VMs, and VM₆; server computer 1324 hosts four VMs identified as VM₇, VM₈, VM₉, VM₁₀. Other server computers may host applications as described above with reference to FIG. 4. For example, server computer 1326 hosts an application identified as App₄.

For the sake of illustration, the data center 1304 and virtualization layer 1302 are shown with a small number of objects. In practice, a typical data centers runs thousands of server computers that are used to run thousands of VMs and containers. Different data centers may include many different types of computers, networks, data-storage systems, and devices connected according to many different types of connection topologies described below.

Computer-implemented methods described herein are performed by an operations manager 1332 that is executed in one or more VMs or containers on the administration computer system 1308. The operations manager 1332 provides several interfaces, such as graphical user interfaces (“GUIs”), for data center management to system administrators and application owners to change parameters and view results of the automated computer-implemented methods described herein. The operations manager 1332 receives numerous streams of time-dependent metric data about the performance or usage of different resources in the data center.

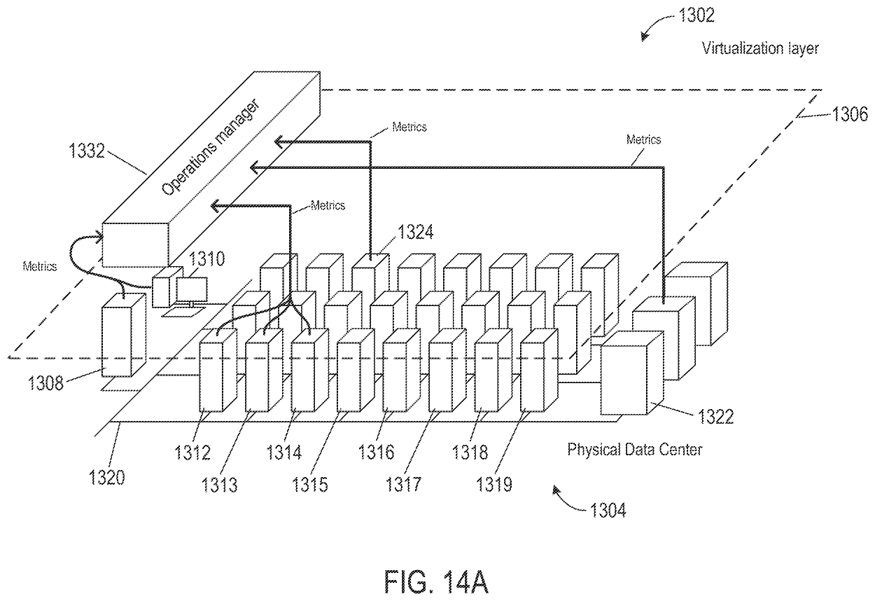

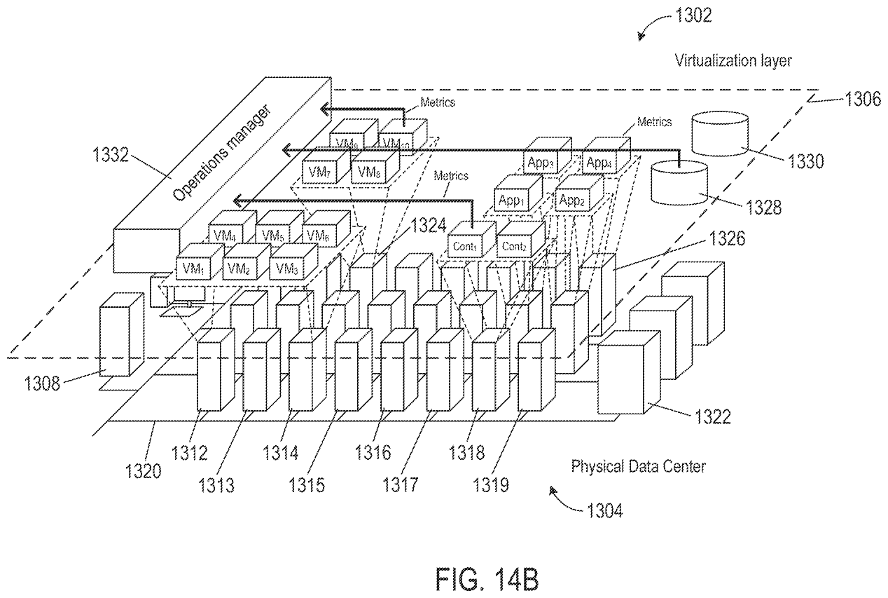

FIGS. 14A-14B show examples of the operations manager 1332 receiving attribute information from physical and virtual objects of the data center 1304. Directional arrows represent metrics sent from physical and virtual resources to the operations manager 1330. In FIG. 14A, the operating systems of PC 1310, server computers 1308 and 1324, and mass-storage array 1322 send metrics to the operations manager 1332. A cluster of server computers 1312-1314 send metrics to the operations manager 1332. In FIG. 14B, the VMs, containers, applications, and virtual storage may independently send metrics to the operations manager 1332. Certain objects may send metric values as the metric values are generated while other objects may only send metrics at certain times or when requested to send metrics by the operations manager 1332.

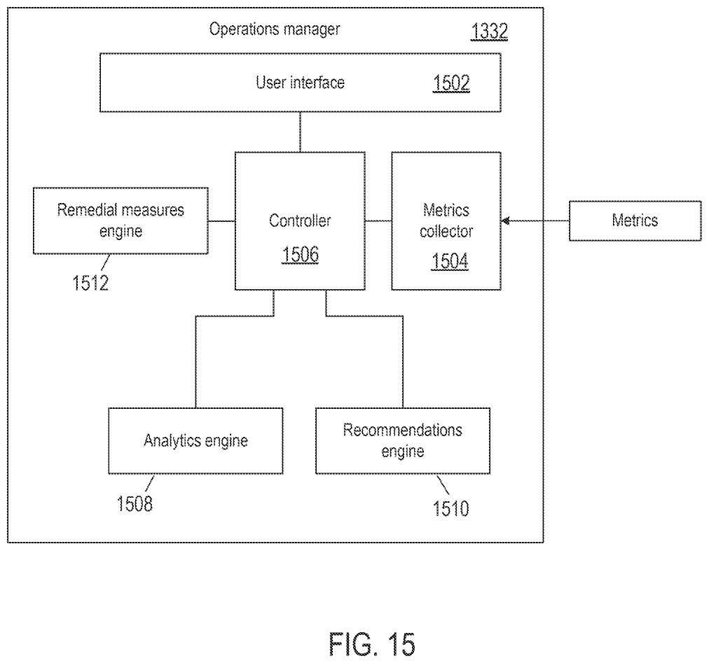

FIG. 15 shows an example architecture of the operations manager 1332. This example architecture of the operations management server 1332 includes a user interface 1502 that provides graphical user interfaces and user interface features for data center management, system administrators, and application owners to receive alerts, clusters of alerts, recommended remedial measures, and execute selected recommended remedial measures. The operations manager 1332 includes a metrics collector 1504 that receives streams of metrics from agents deployed at sources of metric data in the data center. The operations manager 1332 includes a controller 1506 that manages and directs the flow of metrics received by the metrics collector 1504. The controller 1506 manages the user interface 1502, executes instructions received via the user interface 1502, and controls the flow of information displayed by the user interface 1502. The controller 1506 directs the flow of metrics to the analytics engine 1508 as described below. The analytic engine 1508 trains a number of priority models uses the priority models to correctly identify suboptimal resources, as described below. The suboptimal resources include, but are not limited to, idle resources, unused resources, and orphaned resources. The resources include, but are not limited to, VMs, containers, datastores, data storage appliances, network devices, and server computers or hosts. When suboptimal resources have been correctly identified by the analytics engine 1508, the analytics engine 1508 sends instructions to the remedial measures engine 1512 to generate recommended remedial measures for the correctly identified suboptimal resources. The remedial measures engine 1512 generates recommended remedial measures that are sent to the user interface 1502 for display in the graphical user interface of the user's console. The remedial measures engine 1512 executes the remedial measures selected by the user via the graphical user interface.

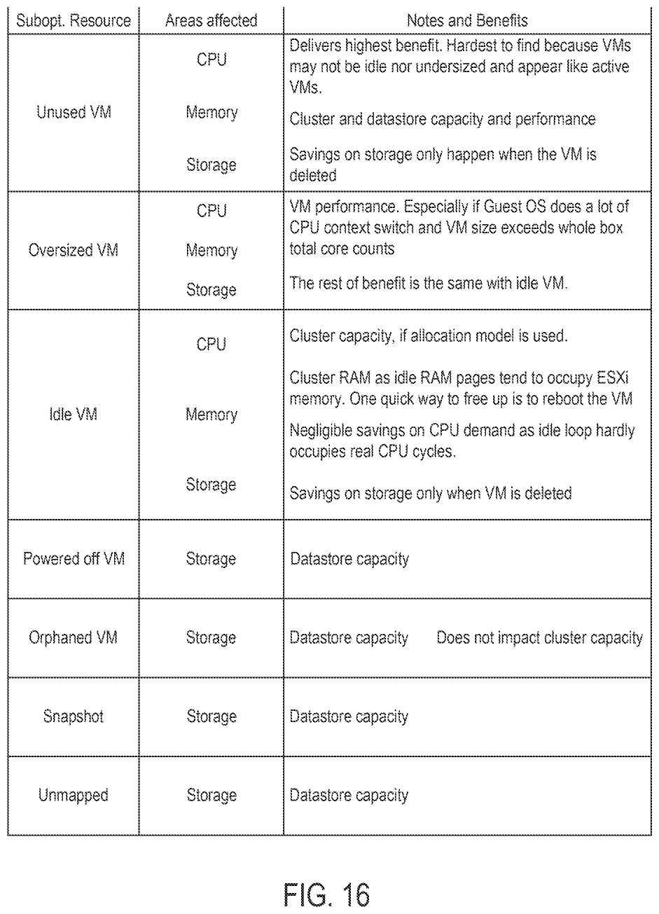

A typical data center can have a variety of suboptimal resources, such as idle VMs, oversized VMs, unused VM, and orphaned hard disks. FIG. 16 shows an example table of suboptimal resources, areas of a data center impacted by the suboptimal resources, and notes and benefits obtained by applying remedial measures to correct the suboptimal resources. For example, an unused VM affects CPU, memory, and storage of a server computer in the data center. However, unused VMs are difficult to detect because unused VMs may not be idle nor are unused VMs undersized. Unused VMs can appear as active VMs. When unused VMs are deleted, storage capacity occupied by the unused VM is freed up. Idle VMs may be remedied by rebooting the VM or by deleting the VM. VMs can become orphaned when a host failover is unsuccessful or when the VM is unregistered server management software of the data center. An orphaned VM is no longer connected to a virtual environment. Orphaned VMs occupy disk space and contribute to VM sprawl and problems with managing a virtual infrastructure. An orphaned VM can either be deleted or recovered by migrating the VM to another host and reregistering the VM with server management software of the data center.

A typical data center may have thousands of suboptimal resources. Typical operations management tools will generate thousands of recommended measures to correct these resources. Resources that have been identified as suboptimal and have been recommended for remedial measures are called “recommended resources.” However, a number of these recommended resources may contain false positives, which are resources that have been mistaken identified as suboptimal. Execution of recommended remedial measures to correct false positives can create a cascade of problems in a data center for other resources that depend on the false positives. These recommended remedial measures are often presented in a tabular form and contain false positive identifications of suboptimal resources, which makes it challenging for the systems administrators to trust recommended remedial measures to correct the suboptimal resources.

Automated computer-implemented methods and system described below using machine learning techniques to improve existing techniques for identifying recommended resources by prioritizing the recommended resources and recommended remedial measures to find the highest priority sub-optimal resources quickly and execute remedial measures in short amount of time. For example, consider the following two scenarios in which a VM has been identified as idle (i.e., suboptimal) by a typical operations management tool:
1) The operations management tool identifies a first VM as an idle VM and two disks are connected to the first VM. These two disks have not had any read or write operations for last 30 days. The operations management tool identifies the two disks as unused disks.
2) The operations management tool also identifies a second VM as an idle VM and two disks are connected to the second VM. In this scenario, however, the two disks have had many read and/or write operations within last 30 days. The operations management tool identifies the two disks as used disks.
   The typical operations management tool identifies both VMs as recommended resources for deletion. With typical operation management tools, a systems administrator will not know which of the two VMs to select for deletion. The systems administrator will have to scroll through the full list of resources to determine manually whether the two disk have been used or not, which may contain thousands of entries resulting errors. In the first scenario above, the first VM has been correctly identified as suboptimal and is a good candidate for deletion. By contrast, the second VM has been incorrectly identified as suboptimal (i.e., false positive) because the second VM has been performing read/write operations with the two disks.

The analytics engine 1508 collects recommended resources and forms a data frame composed of categorical parameters of each resource, categorical variables of each dependent resource, and an initial priority for applying remedial measures to each resource. For example, in the two scenarios above, the idle VM is a recommended resource and the two disks in each scenario are dependent resources. The configuration parameters include, but are not limited to, CPU capacity, memory capacity, and number of network cards, purchase date, and vendor. The categorical variables are truth values that identify dependent resources as optimal or suboptimal. The categorical variables are obtained from typical operations management tool processes. The analytics engine 1508 uses machine learning as described below to classify the recommended resources into multiple classes using a clustering algorithm. Since the recommended resources are already identified as suboptimal resource the cluster that contains the fewest recommended resources are more likely to contain false positives. The analytics engine 1508 uses machine learning as described below to train a priority model for each class of recommended resources. The analytics engine 1508 uses one of the priority models to determine a priority for a recommended resource.

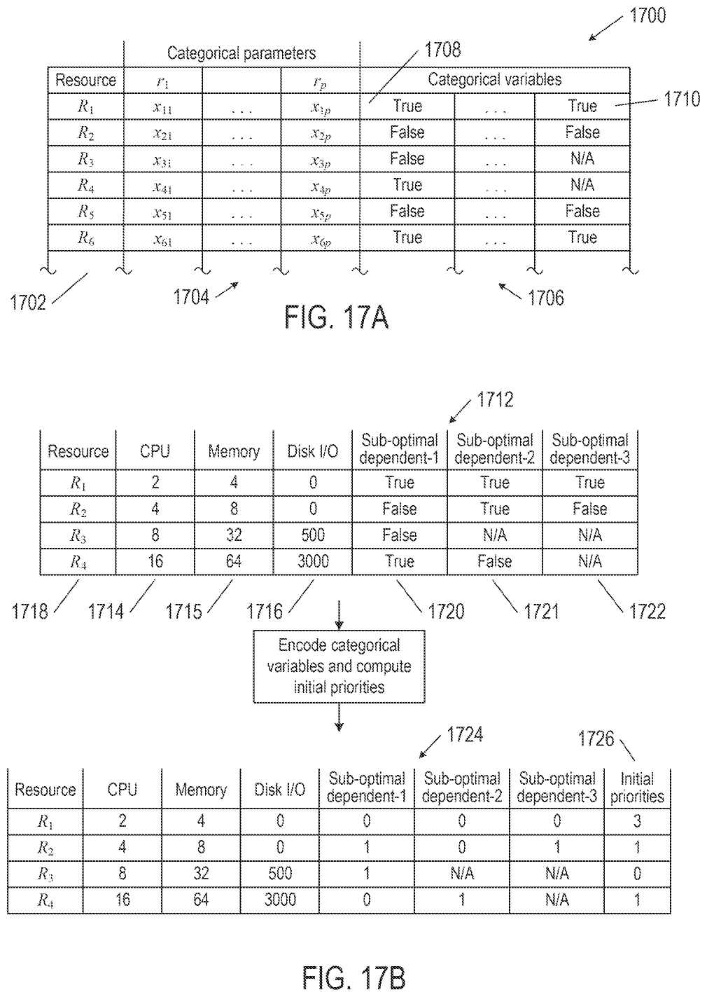

FIG. 17A shows an example table 1700 of recommended resources. The recommended resources are listed in column 1702 and denoted by Rₙ, where n=1, . . . , N, and N is the number of recommended resources in the data center. The categorical parameters in columns 1704 represent attributes of the resources, such as CPU capacity, memory capacity, number of network cards, purchase date, and vendor. The categorical parameters are denoted by xₙⱼ, where i is the resource index, j=1, . . . , p, and p is the number of categorical parameters associated with the recommended resources. The categorical variables in columns 1706 represent dependent resources of the recommended resources that have been identified suboptimal or not suboptimal. These determinations have been determined by an already existing operations management tool as described above. A “True” value means a dependent resource has been determined to be suboptimal. A “False” value means a dependent resource has been previously determined to be not suboptimal. For example, resource R₁ has at least two dependent resources that have been identified as suboptimal as represented by “True” table entries 1708 and 1710.

The analytics engine 1508 encodes categorical variables into numerical values. For example, the “True” variable for a suboptimal dependent resource is encoded as value “0,” and the “False” variable for a dependent resource is encoded as value “1.” The encoded numerical values of the dependent resource of a resource are summed to obtain an initial priority for the resource. In another implementation, the “True” variable for a not suboptimal dependent resource is encoded as value “1,” and the “False” variable for a suboptimal dependent resource is encoded as value “0.”

FIG. 17B shows an example table 1712 of resources and representations of categorical parameters and categorical variables. Columns 1714-1716 list categorical parameters for CPU capacity, memory capacity, and number disk I/Os for four resources listed in column 1718. Columns 1720-1722 list categorical variables for dependent resources of the resources listed in column 1718. For example, two of three dependent resources of the resource R₂ are identified as “False,” which are not suboptimal, and another dependent resource is identified as “True,” which is suboptimal. FIG. 17B includes a table 1724 with identical entries for the resources and categorical parameters in table 1702. The categorical variables have been encoded with binary values “0” for “True” and “1” for “False.” Table 1724 includes a column 1726 with initial priorities assigned to the recommended resources. An initial priority is determined as a count of the number of dependent resources with value “0.” For example, resource R₁ has an initial priority of “3.” Resources R₂ has an initial priority of “1.” Resource R₃ has an initial priority of “0.” The higher the priority associated with a recommended resource, the more likely recommended remedial measures are to be applied to the resource.

The categorical parameters and encoded categorical variables of each recommended resource in a data frame are called resource parameters. The resource parameters form an M-tuple in an M-dimensional space and are denoted by:

$$\\ \begin{matrix}{\vec{X}}_{n} = ( {X}_{n , 1} , {X}_{n , 2} , … , {X}_{n , M} ) & ( 1 )\end{matrix}$$

where n=1, 2, . . . , N.
   For example, the resource parameters in Equation (1) may be partitioned into

$$\\ ( {X}_{n , 1} , {X}_{n , 2} , … , {X}_{n , M} ) = ( {X}_{n , 1} , {X}_{n , 2} , … , {X}_{n , m} ) ⋃ ( {X}_{n , m + 1} , {X}_{n , 2} , … , {X}_{n , M} )$$

where (X_{n,1}, X_{n,2}, . . . , X_{n,m}) represent the categorical parameters of the recommended resource Rₙ and (X_{n,m+1}, X_{n,2}, . . . , X_{n,M}) represent the encoded categorical variables of the recommended resource Rₙ. The full set of resource parameters associated with the full set of recommended resources {Rₙ}₁^{N} is given by:

$$\\ \begin{matrix}X = {\{ {\vec{X}}_{n} \}}_{n = 1}^{N} & ( 2 )\end{matrix}$$

Each resource parameter corresponds to an M-dimensional data point in an M-dimensional space. The resource parameters of the N resources form N data points in the M-dimensional space.

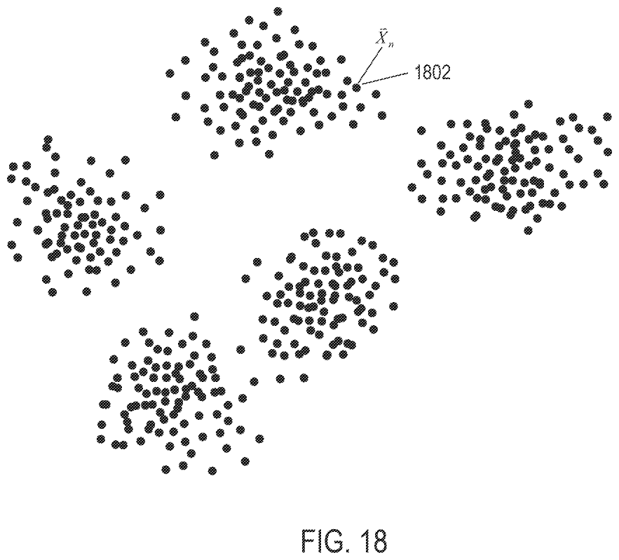

FIG. 18 shows an example plot of resource parameters represented as data points in an M-dimensional space. Each dot, such as dot 1802, represents a data point is an M-tuple in an M-dimensional space and represents resource parameters [symbol] of a recommended resource. As shown in the Example of FIG. 6, the dots appear grouped together into four or five clusters. Each cluster of resource parameters (i.e., data points) comprises similar categorical parameters and encoded categorical variables. In other words, the recommended resources that correspond to the resource parameters in the same cluster have similar attributes.

The analytics engine 1508 applies Gaussian clustering to the full set of data points X to identify different classes of recommended resources. Gaussian clustering is a machine learning technique that extends k-means clustering to determine an appropriate number of clusters, where each cluster corresponds to a different class of recommended resources. Gaussian clustering begins with a small number, k, of cluster centers and iteratively increases the number of cluster centers until the data points in each cluster is distributed in accordance with a Gaussian distribution about the cluster center. The number of initial clusters can be set to a few as one (i.e., k=1). K-means clustering is applied to the full set of data points X for cluster centers denoted by { [symbol] }ⱼ₌₁^{k}. The locations of the k cluster centers are recalculated with each iteration to obtain k clusters. Each data point [symbol] is assigned to one of the k clusters defined by:

$$\\ \begin{matrix}{C}_{i}^{{}_{} ( m )} = \{ {\vec{X}}_{n} : \vert {\vec{X}}_{n} - \vec{q} {}_{i}^{{}_{} ( m )} \vert \leq \vert {\vec{X}}_{n} - \vec{q} {}_{j}^{{}_{} ( m )} \vert ∀ j , 1 \leq j \leq k \} & ( 3 )\end{matrix}$$

where
   cᵢ^{(m)} is the i-th cluster i=1, 2, . . . , k; and
   m is an iteration index m=1, 2, 3, . . . .
      The value of the cluster center [symbol] is the mean value of the data points in the i-th cluster, which is computed as follows:

$$\\ \begin{matrix}\vec{q} {}_{i}^{{}_{} ( m + 1 )} = \frac{1}{\vert {C}_{i}^{{}_{} ( m )} \vert} {\sum }_{{\vec{X}}_{n} ∈ {C}_{i}^{{}_{} ( m )}} {\vec{X}}_{n} & ( 4 )\end{matrix}$$

where |Cᵢ^{(m)}| is the number of data points in the i-th cluster.

For each iteration m, Equation (3) is used to determine if a data point [symbol] that belongs to the i-th cluster followed by computing the cluster center according to Equation (4). The computational operations represented by Equations (3) and (4) are repeated for each value of m until the data points assigned to the k clusters do not change. The resulting clusters are represented by:

$$\\ \begin{matrix}{C}_{i} = {\{ {\vec{X}}_{p} \}}_{p}^{{N}_{i}} & ( 5 )\end{matrix}$$

where
   Nᵢ is the number of data points in the cluster Cᵢ;
   i=1, 2, . . . , k;
   p is a cluster data point subscript; and
   X=C₁∪C₂∪ . . . ∪Cₖ.
      The number of data points in each cluster sums to N (i.e., N=N₁+N₂+ . . . +Nₖ)

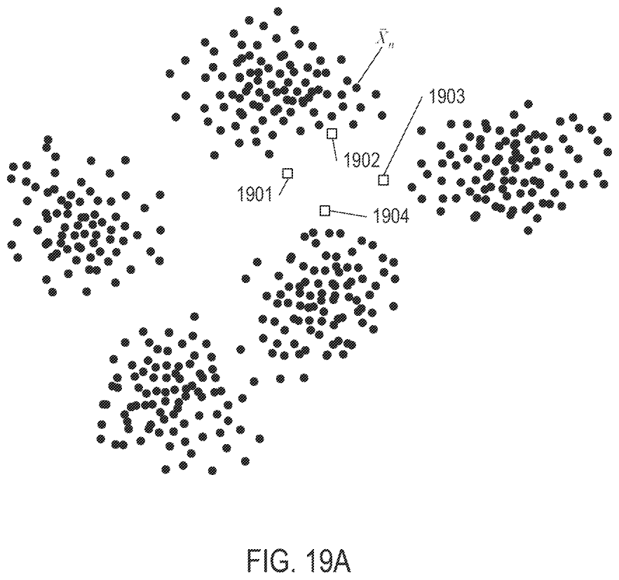

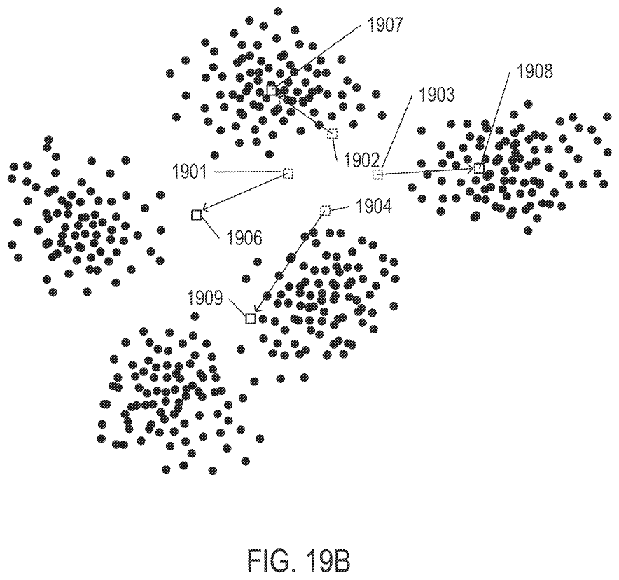

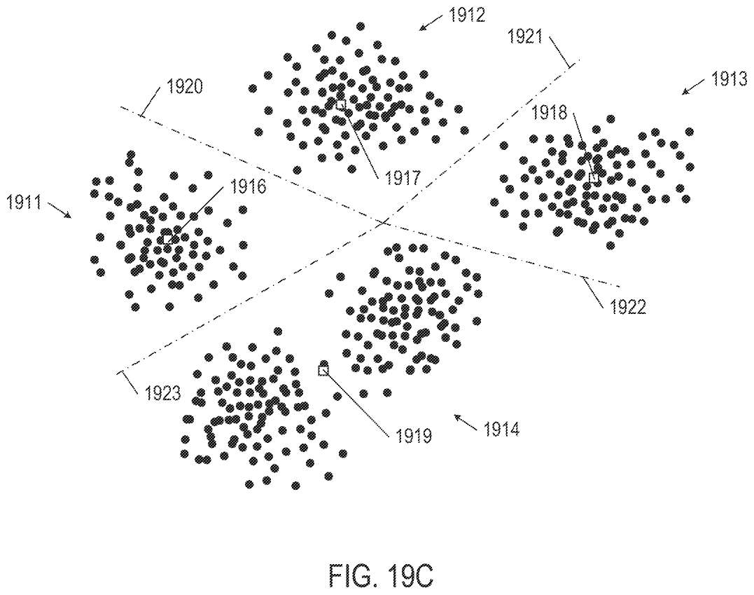

FIG. 19A shows an example of locations for an initial set of k=4 cluster centers represented by squares 1901-1904. The four cluster centers 1901-1904 may be placed anywhere within the M-dimensional space. K-means clustering as described above with reference to Equation (3) and (4) is applied until each of the data points have been assigned to one of four clusters. FIG. 19B shows a snapshot of an intermediate step in k-means clustering in which the cluster centers have moved from initial locations 1901-1904 to intermediate locations represented by squares 1906-1909, respectively. FIG. 19C shows a final clustering of the data points into four clusters 1911-1914 with cluster centers 1916-1919 located at the center of each of the clusters for k-mean clustering with k=4. Dot-dash lines 1920-1923 have been added to mark separation between the four clusters 1911-1914.

Each cluster is tested to determine whether the data points assigned to a cluster are distributed according to a Gaussian distribution about the corresponding cluster center. A confidence level, α, is selected for the test. For each cluster Cᵢ, two child cluster centers are initialized as follows:

$$\\ \begin{matrix}\vec{q} {}_{i}^{+} = {\vec{q}}_{i} + \vec{m} & ( 6 a )\end{matrix}$$

$$\\ \begin{matrix}\vec{q} {}_{i}^{-} = {\vec{q}}_{i} - \vec{m} & ( 6 b )\end{matrix}$$

In one implementation, the vector [symbol] is an M-dimensional randomly selected vector with the constraint that the length ∥ [symbol] ∥ is small compared to distortion in the data points of the cluster. In another implementation, principal component analysis is applied to data points in the cluster Cᵢ to determine the eigenvector, [symbol] , with the largest eigenvalue. The eigenvector [symbol] points in the direction of greatest spread in the cluster of data points and is identified by the corresponding largest eigenvalue. In this implementation, the vector [symbol] = [symbol] \sqrt{2λ/π}.

K-means clustering, as described above with reference to Equations (3) and (4), is then applied only to data points in the cluster Cᵢ for the two child cluster centers [symbol] ᵢ⁺ and [symbol] ᵢ⁻. The two child cluster centers are relocated to identify two sub-clusters of the original cluster Cᵢ. When the final iteration of k-means clustering applied to data points in the cluster Cᵢ is complete, the final relocated child cluster centers are denoted by [symbol] ᵢ⁺′ and [symbol] ᵢ⁻′, and an M-dimensional vector is formed between the relocated child cluster centers [symbol] ᵢ⁺′ and [symbol] ᵢ⁻′ as follows:

$$\\ \begin{matrix}\vec{v} = \vec{q} {}_{i}^{{}_{} + ′} - \vec{q} {}_{i}^{{}_{} - ′} & ( 7 )\end{matrix}$$

The data points in the cluster Cᵢ are projected onto a line defined by the vector [symbol] as follows:

$$\\ \begin{matrix}{X}_{p}^{{}_{} ′} = \frac{{\vec{X}}_{p} \cdot \vec{v}}{‖ \vec{v} ‖} & ( 8 )\end{matrix}$$

A set of projected data points is given by

$$\\ \begin{matrix}{C}_{i}^{{}_{} ′} = {\{ {X}_{p}^{{}_{} ′} \}}_{p}^{{N}_{i}} & ( 9 )\end{matrix}$$

The projected data points lie along the vector [symbol] . The projected data points are transformed to zero mean and a variance of one by applying Equation (10) as follows:

$$\\ \begin{matrix}{X}_{( p )}^{{}_{} ′} = \frac{{X}_{p}^{{}_{} ′} - μ}{V} & ( 10 )\end{matrix}$$

The mean of the projected data points is given by

$$\\ \begin{matrix}μ = \frac{1}{{N}_{i}} {\sum }_{p}^{{N}_{i}} {X}_{p}^{{}_{} ′} & ( 11 )\end{matrix}$$

The variance of the projected data points is given by:

$$V = \frac{1}{{N}_{i}} {\sum }_{p}^{{N}_{i}} {( {X}_{p}^{′} - μ )}^{2} \qquad ( 12 )$$

The set of projected data points with zero mean and variance of one is given by:

$${C}_{( i )}^{′} = {\{ {X}_{( p )}^{′} \}}_{p}^{{N}_{i}} \qquad ( 13 )$$

The cumulative distribution function for a normal distribution with zero mean and variance one, N(0,1), is applied to the projected data points in Equation (13) to compute a distribution of projected data points:

$${Z}_{( i )} = {\{ {z}_{p} \}}_{p}^{{N}_{i}} \qquad ( 14 )$$

$$where {z}_{p} = \frac{1}{2} [ 1 + erf ( \frac{{X}_{( p )}^{′}}{\sqrt{2}} ) ]$$

A statistical test value is computed for the distribution of projected data points:

$${A}_{*}^{2} ( {Z}_{( i )} ) = A ( {Z}_{( i )} ) ( 1 + \frac{4}{{N}_{i}} - \frac{25}{{N}_{i}^{2}} ) \qquad ( 15 )$$

$$where A ( {Z}_{( i )} ) = - \frac{1}{{N}_{i}} {\sum }_{p = 1}^{{N}_{i}} ( 2 p - 1 ) [ ln ( {z}_{p} ) + ln ( 1 - {z}_{{N}_{i} + 1 - p} ) ] - {N}_{i}$$

When the statistical test value is less than the confidence level represented by the condition

$${A}_{*}^{2} ( {Z}_{( i )} ) < α \qquad ( 16 )$$

the relocated child cluster centers [symbol] ᵢ⁺′ and [symbol] ᵢ⁻′ are rejected and the original cluster center [symbol] ᵢ is accepted. On the other hand, when the condition in Equation (16) is not satisfied, the original cluster center [symbol] ᵢ is rejected and the relocated child cluster centers [symbol] ᵢ⁺′ and [symbol] ᵢ⁻′ are accepted as the cluster centers of two sub-clusters of the original cluster.

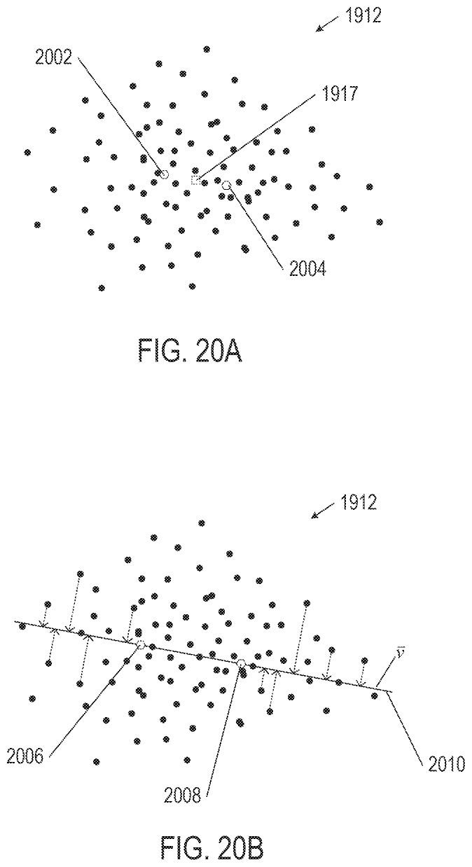

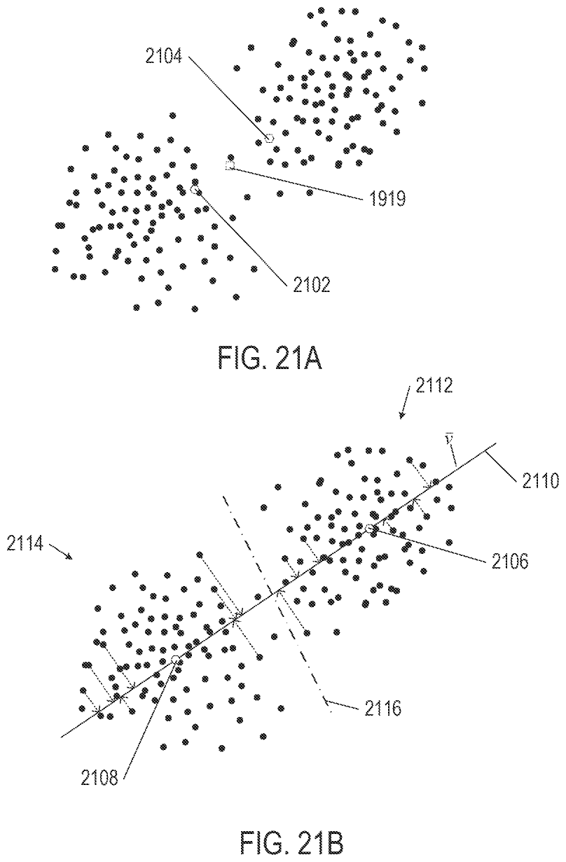

FIGS. 20A-21B show application of Gaussian clustering to the clusters 1912 and 1914 shown in FIG. 19C. FIG. 20A shows an enlargement of the cluster 1912 in FIG. 19C. Hexagonal shapes 2002 and 2004 represent initial coordinate locations of two child cluster centers determined as described above with reference to Equations (6a) and (6b). K-means clustering is applied to the data points in the cluster 1912 for k=2, as described above with reference to Equations (3) and (4). FIG. 20B shows child cluster centers 2006 and 2008 that result from application of k-means clustering. Line 2010 is a line in the direction of a vector [symbol] formed between the two child cluster centers 2006 and 2008 as described above with reference to Equation (7). Dotted directional arrows represent projection of the data points onto the line 2010 as described above with reference to Equation (8). In this example, when the cumulative distribution function for zero mean and variance one of Equation (14) is applied to the cluster of projected data points along the line 2010, the statistical test value would satisfy the condition given by Equation (16) because the data are not Gaussian distributed about the two child cluster centers 2006 and 2008. As a result, the two child cluster centers 2006 and 2008 would be rejected and the original cluster center 1917 would be retained as the cluster center of the cluster 1912.

FIG. 21A shows an enlargement of the cluster 1914 in FIG. 19C. Hexagonal shapes 2102 and 2104 represent initial coordinate locations of two child cluster centers determined as described above with reference to Equations (6a) and (6b). K-means clusters is applied to the data points in the cluster 1914 for k=2, as described above with reference to Equations (3) and (4). FIG. 21B shows child cluster centers 2106 and 2108 that result from the application of k-means clustering. Line 2110 is a line in the direction of a vector [symbol] formed between the two child cluster centers 2106 and 2108 as described above with reference to Equation (7). Dotted directional arrows represent projecting the data points onto the line 2110 as described above with reference to Equation (8). In this example, when the cumulative distribution function for zero mean and variance one of Equation (14) is applied to the cluster of projected data points along the line 2110, the statistical test value does not satisfy the condition given by Equation (16) because the data points are Gaussian distributed about the two child cluster centers 2106 and 2108. As a result, the two child cluster centers 806 and 808 are retained to form two new clusters 2112 and 2114 that result from applying k-means clustering to the two cluster centers 2106 and 2108. Dot-dash line 2116 marks separation between the clusters 2112 and 2114. The same procedure would then be applied separately to the clusters 2112 and 2114.

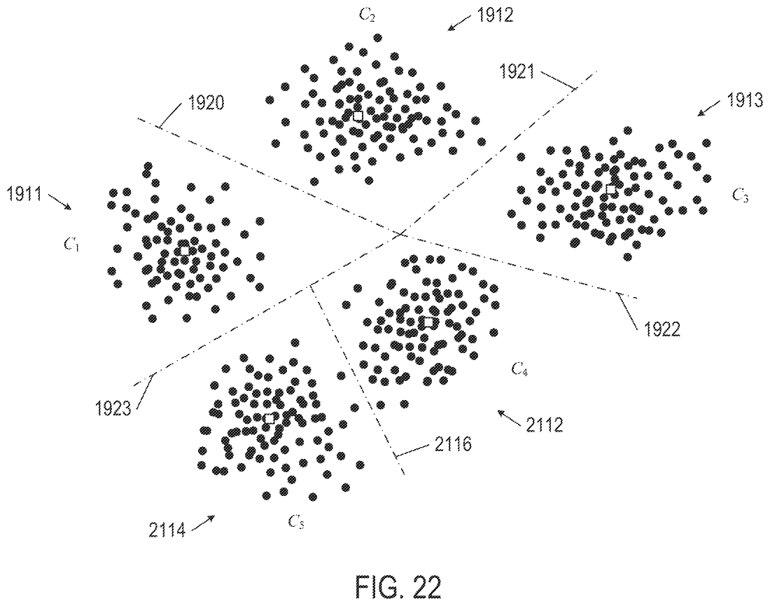

FIG. 22 shows the full set of data points X clustered into five clusters 1911, 1912, 1913, 2112, and 2114 obtained with Gaussian clustering. Each cluster of data points represents a different class of recommended resources. For example, if the data points represent resource parameters, then each cluster represents recommended resources with similar resource parameters.

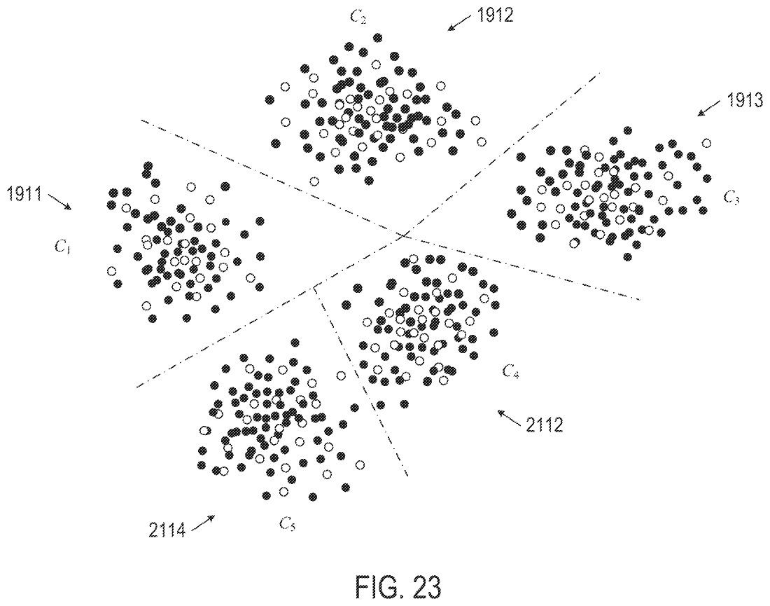

The analytics engine 1508 uses machine learning to determine a priority model for each class of recommended resources. Each class corresponds to a cluster of Nᵢ data points that is partitioned into training data and validation data. The number of data points in the training data is denoted by L and the number of data points in the validation data is given Nᵢ−L, with the validation data set having fewer data points. Each cluster may be partitioned into training data and validation data by randomly selecting data points to serve as training data while the remaining data points are used as validation data. For example, in certain implementations, each cluster of data points may be partitioned into 70% training data and 30% validation data. In other implementations, each cluster of data points may be partitioned into 80% training data and 20% validation data. In still other implementations, each cluster of data points may be partitioned into 90% training data and 10% validation data. FIG. 23 shows the five clusters of FIG. 22 partitioned into 70% training data represented by solid black dots and 30% validation data represented by open dots.

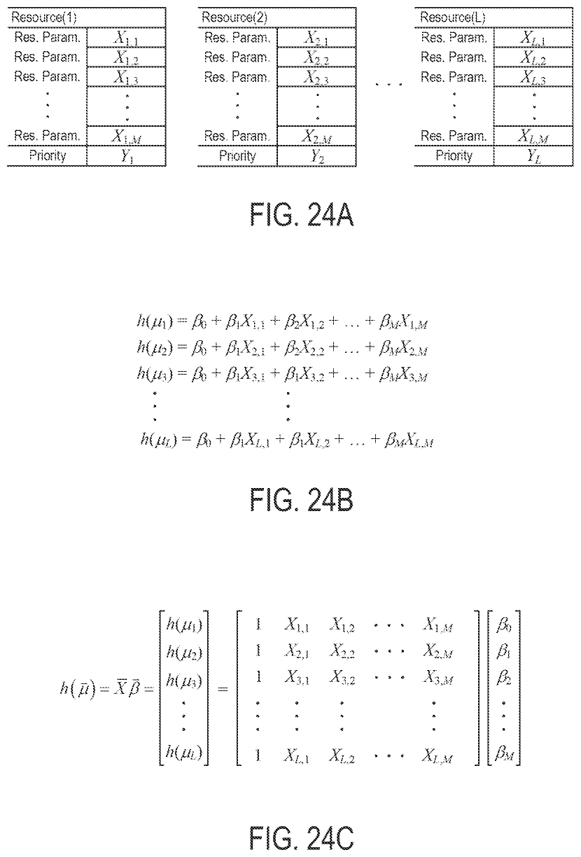

The L training data points of a cluster are used to construct a priority model for the cluster. FIG. 24A shows categorical parameters and encoded categorical variables for L sets of training data. The L sets of training data are randomly selected from the Nᵢ data points of a cluster (i.e., resource parameters of a class), as described above with reference to FIG. 23. A priority model is represented by

$$h ( {μ}_{l} ) = {β}_{0} + {β}_{1} {X}_{l , 1} + {β}_{2} {X}_{l , 2} + … + {β}_{M} {X}_{l , M} \qquad ( 17 )$$

where
   β₀, β₁, β₂, . . . , β_{M} are predictor coefficients;
   X_{l,1}, X_{l,2}, . . . , X_{l,M} represent resource parameters of the l-th recommended resource of the L training data;
   μₗ is a linear predictor for the i-th cluster; and
   h(⋅) is a link function that links the priority model, predictor coefficients, and the resource parameters. FIG. 24B shows a system of equations formed from the resource parameters associated with each set of training data as described above with reference to Equation (17). Each equation comprises the same set of predictor coefficients and corresponds to one set of the training data shown in FIG. 24A. FIG. 24C shows the system of equations of FIG. 24B rewritten in matrix form. A link function h(⋅) is determined from the training data for each cluster.

The priorities Y₁, Y₂, . . . , Y_{L} are dependent variables that are distributed according to a particular distribution, such as the normal distribution, binomial distribution, Poisson distribution, and Gamma distribution, just to name a few. The linear predictor h(⋅) is the expected value of the priorities and is given by:

$${μ}_{l} = E ( {Y}_{l} ) \qquad ( 18 )$$

Examples of link functions are listed in the following Table:

| Link Function | ηₗ = h(μₗ) | μₗ = h⁻¹(ηₗ) |
|---|---|---|
| Identity | μₗ | μₗ |
| Log | ln(μₗ) | e^{h(μ}^{ₗ}⁾ |
| Inverse | μₗ⁻¹ | h(μₗ)⁻¹ |
| Inverse-square | μₗ⁻² | h(μₗ)^{-1/2} |
| Square-root | \sqrt{μₗ} | h(μₗ)² |

For example, when the priorities are distributed according to a Poisson distribution, the link function is the log function. When the priorities are distributed according to a Normal distribution, the link function is the identity function.

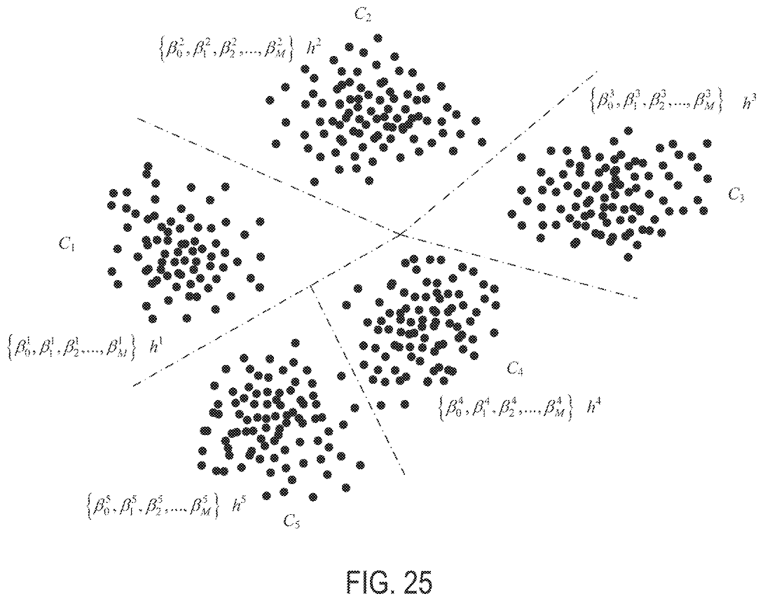

The system of equations in FIGS. 24B and 24C is solved separately for each cluster to obtain a corresponding set of predictor coefficients of a priority model. FIG. 25 shows the five clusters 1911, 1912, 1913, 2112, and 2114 of data points and corresponding predictor coefficients β₀ⁱ, β₁ⁱ, β₂ⁱ, . . . , β_{M}ⁱ and link functions hⁱ, where superscript cluster index i=1, . . . , 5. For each cluster, the predictor coefficients can be iteratively determined with the r-th iteration given by:

$${β}_{m}^{( r + 1 )} = {β}_{m}^{( r )} + S ( {β}_{m}^{( r )} ) E ( H ( {β}_{m}^{( r )} ) ) \qquad ( 19 )$$

where
   m=1, . . . , M;
   S(βₘ^{(r)}) is a Taylors expansion of βₘ^{(r)}; and
   H(βₘ^{(r)}) is the Hessian matrix of βₘ^{(r)}.
   After the
      The predictor coefficients can be computed iteratively using iterative weighted least squares.

The validation data of a cluster is used to validate the iteratively computed prediction parameters of the corresponding priority model. Consider a set of predictor coefficients β₁^{j}, B₂^{j}, . . . , B_{M}^{j} obtained as described for the j-th cluster Cⱼ using the training data of the j-th cluster. Let the validation data for a validation data point in the j-th cluster Cⱼ be represented by the resource parameters X₁^{j}, X₂^{j}, . . . , X_{M}^{j} and corresponding an actual priority Y^{j}. The resource parameters are substituted into the priority model of the j-th cluster to obtain an approximate priority as follows:

$${Y}_{0}^{j} = {h}^{- 1} ( {β}_{0}^{j} + {β}_{1}^{j} {X}_{1}^{j} + {β}_{2}^{j} {X}_{2}^{j} + … + {β}_{M}^{j} {X}_{M}^{j} ) \qquad ( 20 a )$$

where Y₀^{j} is the approximate priority of the actual priority Y^{j}.
   The operation of Equation (20a) is repeated for the resource parameters of each of the Nⱼ−L validation data points of the validation data in the j-th cluster Cⱼ to obtain a set of corresponding approximate priorities:

$${\vec{Y}}_{0} = \{ {Y}_{0}^{1} , {Y}_{0}^{2} , … , {Y}_{0}^{{N}_{j} - L} \}$$

The set of actual priorities of the resource parameters in the validation data are given by

$$\vec{Y} = \{ {Y}^{1} , {Y}^{2} , … , {Y}^{{N}_{j} - L} \}$$

When the approximate priorities for the validation data satisfy the condition

$$‖ {\vec{Y}}_{0} - \vec{Y} ‖ < ε \qquad ( 20 b )$$

where
   ∥⋅∥ is the Euclidean distance; and
   ε is an acceptable threshold (e.g., ε=0.01),
      the iteratively determined predictor coefficients of the cluster are acceptable for use in computing an unknown priority for a recommended resource.

The priority models can be used to compute a priority \tilde{Y} for a resource R_{b} of the data center. Let [symbol] _{b} be the resource parameters of the resource R_{b} determined as described above with reference to FIG. 17B. The resource R_{b} may be a new resource added to the data center and have an unknown priority, or the resource R_{b} may be a recommended resource for remedial measures. For each cluster of recommended resources, a sum of square distances is computed from the resource parameters of the resource R_{b} to the resource parameters of each recommended resource in each cluster as follows:

$${D}_{i} = {\sum }_{n = 1}^{{N}_{i}} {‖ {\vec{X}}_{b} - {\vec{X}}_{n}^{i} ‖}^{2} \qquad ( 21 )$$

where
   subscript i is a cluster index;
   ∥⋅∥² is the square Euclidean distance in an M-dimensional space;
   [symbol] ₙⁱ is the n-th data point in the cluster Cᵢ; and
   [symbol] _{b} is an M-tuple of resource parameters for the resource R_{b}.
      The resource R_{b} is assumed to belong to the cluster with the smallest square distance in the set of square distances denoted by {D₁, D₂, . . . , D_{N}}. For example, the square distances obtained in Equation (21) for each cluster can be rank ordered to determine the minimum square distance in the set of square distances denoted by:

$${D}_{j} = min \{ {D}_{1} , {D}_{2} , … , {D}_{N} \} \qquad ( 22 )$$

The resource R_{b} belongs to the j-th cluster Cⱼ with the minimum square distance in Equation (22). An approximation of the priority of the resource R_{b} is computed from the priority model of the j-th cluster Cⱼ as follows:

$${\tilde{Y}}^{b} = {h}^{- 1} ( {β}_{0}^{j} + {β}_{1}^{j} {X}_{1}^{u} + {β}_{2}^{j} {X}_{2}^{u} + … + {β}_{M}^{j} {X}_{M}^{u} ) \qquad ( 23 )$$

In other words, \tilde{Y}^{b} is the priority of the resource R_{b}.

The magnitude of the priority \tilde{Y}^{b} of the resource R_{b} reveals how likely, or to what degree, the resource is to being suboptimal. For example, the larger the value of the priority \tilde{Y}^{b} of the resource R_{b} the more likely the resource is truly a suboptimal resource in need of recommended remedial measures. In one implementation, when the priority of the resource is greater than a priority threshold (e.g., \tilde{Y}^{b}>Th_{priority}), the resource is considered a suboptimal resource. The analytics engine 1508 directs the remedial measure engine 1512 to execute recommended remedial measures, thereby automatically correcting the recommended resource R_{b}. The priority threshold is a user selected numerical value, such as 4, 5, or 10. In another implementation, when the priority is greater than the priority threshold (e.g., \tilde{Y}^{b}>Th_{priority}), a systems administrator is notified via an alert in a graphical user interface of a console the recommended resources R_{b} and recommended remedial measures for correcting the resource. The system administrator may select via the graphical user interface of the operations manager 1332 to delete the resource R_{b}, migrate the resource R_{b} to another host, increase CPU allocation to the resource, increase memory allocation to the resource R_{b}, or execute any one or many remedial measures described above. The remedial measure engine 1512 executes the user-selected remedial measures for the resource R_{b}. When a user executes any remedial measures on the resource R_{b}, the training data of the j-th cluster Cⱼ is updated with the resource R_{b} and the corresponding priority \tilde{Y}^{b}. The priority model of the j-th cluster Cⱼ is retrained based on the added resource R_{b} and the corresponding priority \tilde{Y}^{b}.

The computer-implemented processes described above improve on the previous techniques executed by type operations management tool by giving assigning priorities to recommended resource, which eliminate human errors in identification of false positive recommended resources and eliminates erroneous execution of remedial measures to correct false positive recommended resources. The computer-implemented processes aid systems administrator to take immediate corrective action on actual high priority suboptimal resources without manually checking the full list of suboptimal resources for false positives.

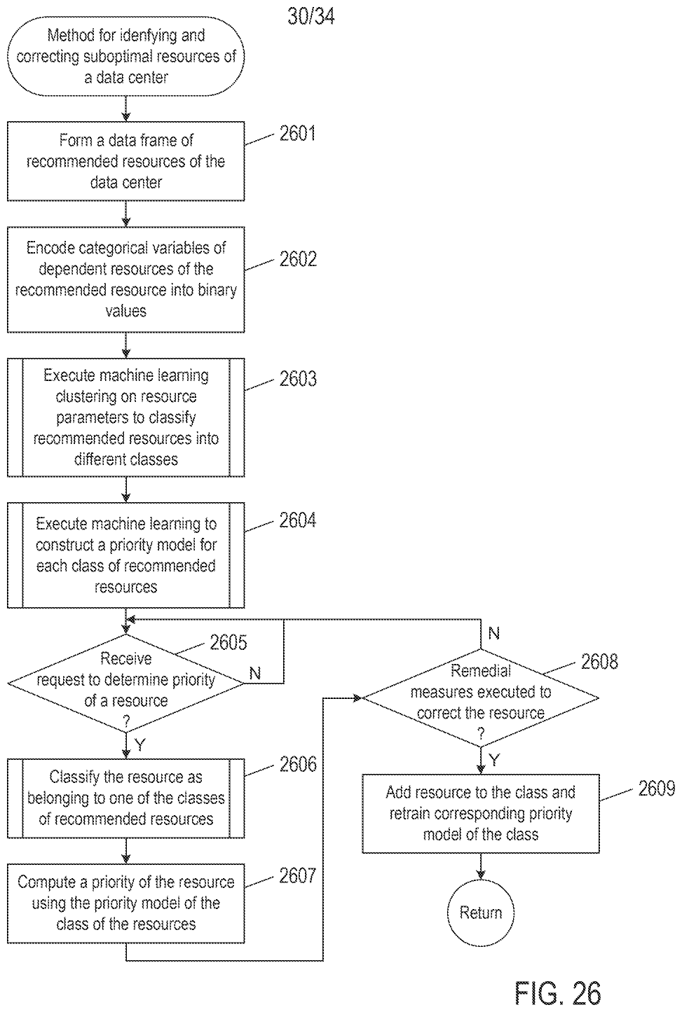

The methods described below with reference to FIGS. 26-30 are stored in one or more data-storage devices as machine-readable instructions and are executed by one or more processors of a computer system, such as the computer system shown in FIG. 1.

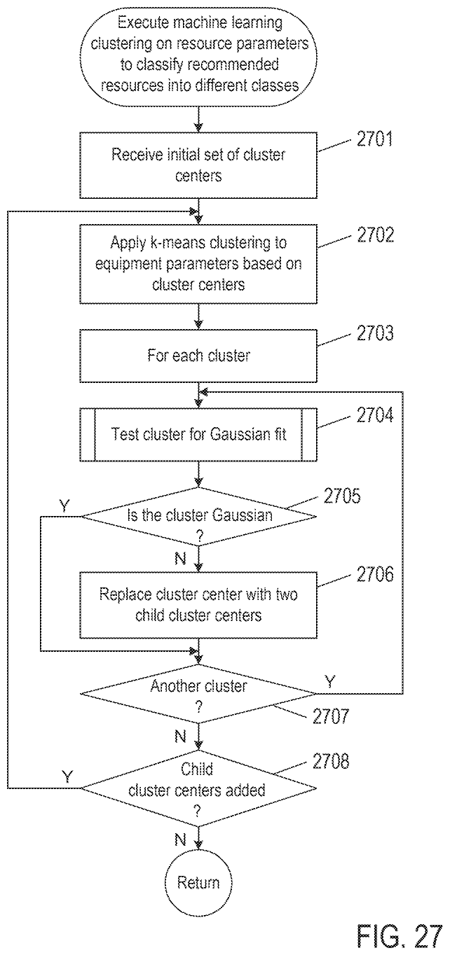

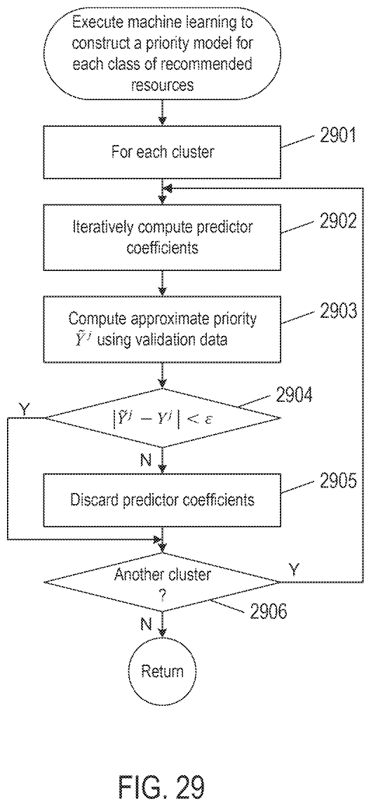

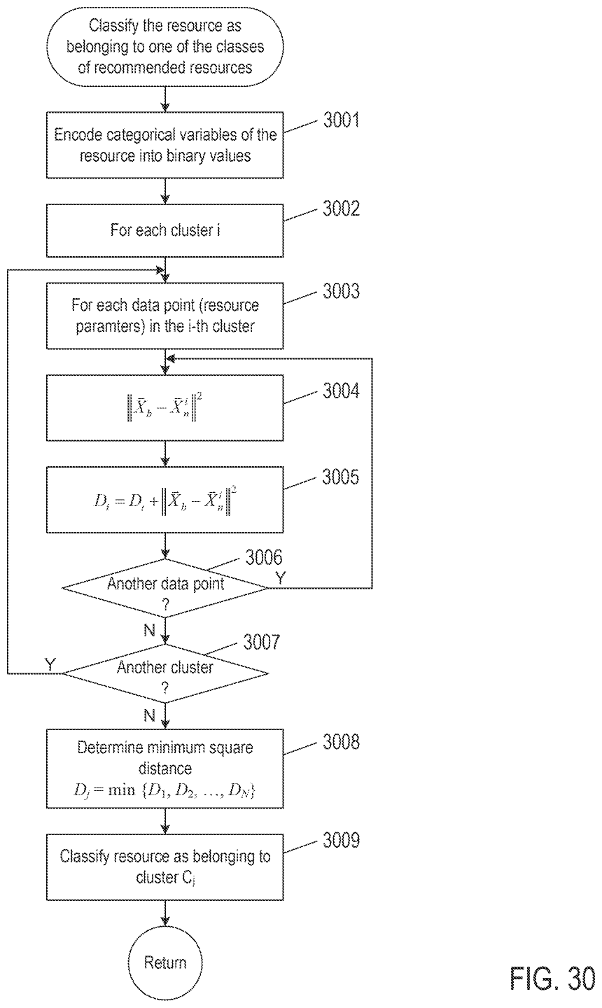

FIG. 26 shows a control-flow diagram of a method for identifying and correcting suboptimal resources of a data center. In block 2601, a data frame of recommended resources is formed from categorical parameters and categorical variables of the recommended resources as described above with reference to FIGS. 17A-17B. In block 2602, categorical variables of recommended resources in the data frame are encoded into binary values as described above with reference to FIG. 17B. The categorical parameters and the encoded categorical variables of the recommended resources are the resource parameters of the recommended resources. In block 2603, an “execute machine learning clustering on resource parameters to classify recommended resources into different classes” procedure is performed. An example implementation of the “execute machine learning clustering on resource parameters to classify recommended resources into different classes” procedure is described below with reference to FIG. 27. In block 2604, a “execute machine learning to construct a priority model for each class of recommended resources” procedure is performed. An example implementation of the “execute machine learning to construct a priority model for each class of recommended resources” procedure is described below with reference to FIG. 29. In decision block 2605, when a request to determine priority of a resource is received, control flows to block 2606. In block 2606, a “classify the resource as belonging to one of classes of recommended resources” procedure is performed. An example implementation of the “classify the resource as belonging to one of classes of recommended resources” procedure is described below with reference to FIG. 30. In block 2607, a priority of the resource is computed using the priority model of the class of the resource as described above with reference to Equation (23). In block 2608, when the operations manager 1332 executes remedial measures to correct the resource, control flows to block 2609. In block 2609, the resource is added to the class and the priority model of the class is retrained.

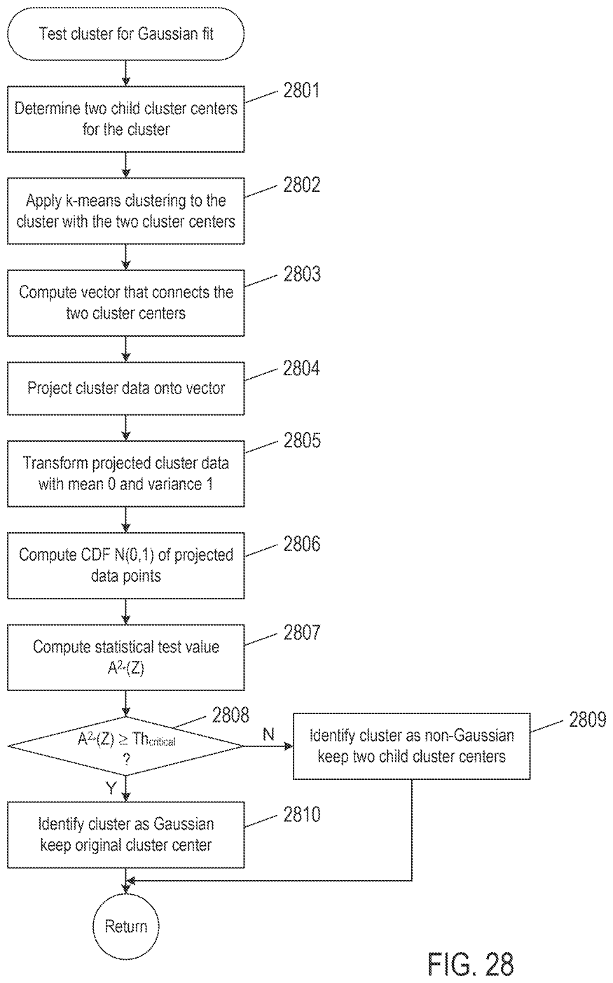

FIG. 27 shows a flow diagram of an example implementation of the “execute machine learning clustering on resource parameters to classify recommended resources into different classes” called in block 2603 of FIG. 26. In block 2701, an initial set of cluster centers is received. The initial set of cluster centers are predetermined and may be initial to one (i.e., k=1). In block 2702, k-mean clustering is applied to the data points to determine clusters of data points as described above with reference to Equations (3) and (4). A loop beginning with block 2703 repeats the computational operations represented by blocks 2704-2706 for each cluster determined in step 1502. In block 2704, a “test cluster for Gaussian fit” procedure is performed. An example implementation of “test cluster for Gaussian fit” procedure is described below with reference to FIG. 28. In decision block 2704, if the cluster identified in block 2704 is Gaussian, control flows to block 2707. Otherwise, control flows to block 2706 in which the cluster center of the cluster of data points is replaced by two child cluster centers obtained in block 2704. In decision block 2707, if all clusters identified in block 2702 have been considered, control flows to decision block 2708. In decision block 2708, if any cluster centers have been replaced by two child cluster centers, control flows to block 2702.

FIG. 28 shows a flow diagram of an example implementation of the “test cluster for Gaussian fit” procedure called in block 2704 of FIG. 27. In block 2801, two child cluster centers are determined for the cluster based on the cluster center in accordance with Equations (6a) and (6b). In block 2802, k-means clustering is applied to the cluster using the child cluster centers to identify two clusters within the cluster, each cluster having one of the relocated child cluster centers. In block 2803, compute a vector that connects the relocated two child cluster centers in accordance with Equation (7). In block 2804, the data points of the cluster are projected onto a line defined by the vector in accordance with Equation (8). In block 2805, the projected cluster data points are transformed to data points with a mean zero and variance one as described above with reference to Equations (10)-(12). In block 2806, the normal cumulative distribution function with zero mean and variance one is applied to the projected data points as described above with reference to Equation (14) to obtain a distribution of projected data points. In block 2807, a statistical test value is computed from the distribution of projected data points according to Equation (15). In decision block 2808, when the statistical test value is greater than a critical threshold, as described above with reference to Equation (16), control flows block 2810. Otherwise, control flows to block 2809. In block 2809, the cluster is identified as non-Gaussian and two relocated child cluster centers are used to replace the original cluster center. In block 2810, the cluster is identified as Gaussian and two relocated child cluster centers are rejected and the original cluster center is retained.

FIG. 29 shows a flow diagram of an example implementation of the “execute machine learning to construct a priority model for each class of recommended resources” procedure called in block 2604 of FIG. 26. A loop beginning with block 2901 repeats the computational operation of block 2902-2905 for each cluster determined in block 2603 of FIG. 26. In block 2902, iteratively computer predictor coefficients, as described above with reference to Equation (19). In block 2903, compute approximate priority using the priority model as described above with reference to Equation (20a). In decision block 2904, when the condition of Equation (20b) is satisfied for the approximate priority and the priorities of the validation data, control flow to decision block 2906. Otherwise, control flows to block 2905. In block 2905, the predictor coefficients are discarded. In decision block 2906, controls flow back to block 2902 for another cluster.

FIG. 30 shows a flow diagram of an example implementation of the “classify the resource as belonging to one of classes of recommended resources” procedure called in block 2606 of FIG. 26. In block 3001, categorical variables of the resource are encoded into binary values as described above with reference to FIG. 17B. A loop beginning with block 3002 repeats the computational operations represented by blocks 3003-3006 for each cluster determined in block 2603 of FIG. 26. A loop beginning with block 3003 repeats the computational operations represented by blocks 3004 and 3005 for each data point in the cluster. In block 3004, a square distance is computed as described above with reference to Equation (19) between the resource parameters of recommended resource of the cluster and the resource parameters of the resource. In block 3005, a sum of the square distances computed in block 3004 is formed. In decision block 3006, blocks 3004 and 3005 are repeated until all data points (i.e., resource parameters) of the cluster have been considered. In decision block 3007, blocks 3003-3006 are repeated for another cluster until all clusters have been considered. In block 3008, a minimum of the square distances is determined as described above with reference to Equation (20). In block 3009, the resource is classified as belonging to the class with the minimum square distance.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An automated computer-implemented method for identifying and correcting suboptimal resources of a data center, the method comprising:
executing machine learning clustering to classify recommended resources into different classes according to resource parameters of the recommended resources;
executing machine learning to construct a priority model for each class of recommended resources;
in response to receiving a request to determine priority of a resource,
determining a class of the classes the resource belongs to, and
using the priority model of the class to compute a priority of the resource; and
executing remedial measures to correct the resource based on the priority, wherein executing remedial measures includes deleting the resource, restarting the resource, and migrating the resource to a different host.

2. The method of claim 1 wherein executing machine learning clustering to classify recommended resources into different classes comprises:
forming a data frame of recommended resources, the data frame including categorical parameters of each recommended resource and categorical variables of dependent resources of each resource; and
encoding the categorical variables into numerical values, the categorical parameters and the encoded categorical variables forming the resource parameters of each recommended resource.

3. The method of claim 1 wherein executing machine learning to construct a priority model for each class of recommended resources comprises:
applying k-means clustering to the categorical parameters and the encoded categorical variables of the resources based on an initial set of cluster centers; and
for each cluster,
testing a cluster for fit to a Gaussian distribution,
replacing cluster center with two child cluster centers when the cluster does not fit a Gaussian distribution, and
applying k-means clustering to the two child cluster centers.

4. The method of claim 1 where executing machine learning to construct a priority model for each class of recommended resources comprises:
for each class of the classes,
partitioning the resource parameters of the resources in the class into training data and validation data;
iteratively computing predictor coefficients of a priority model of the class based on the training data;
computing approximate priorities using the priority model applied to the validation data associated with the class, the approximate priorities approximate the actual priority of the validation data; and
discarding the predictor coefficients when a difference between the approximate priorities and corresponding priorities of the validation data exceeds a threshold.

5. The method of claim 1 wherein determining a class of the classes the resource belongs to comprises:
computing a squared distance between the resource parameters of the resource and resource parameters of each resource of the classes;
determining a minimum squared distance of the squared distances; and
assigning the resource to the class having the minimum squared distance to the resource.

6. The method of claim 1 further comprising:
adding the resource to the class, and
retraining the priority model for the class with the resource added.

7. A computer system for identifying and correcting suboptimal resources of a data center, the computer system comprising:
one or more processors;
one or more data-storage devices; and
machine-readable instructions stored in the one or more data-storage devices that when executed using the one or more processors control the system to performance operations comprising:
executing machine learning clustering to classify recommended resources into different classes according to resource parameters of the recommended resources;
executing machine learning to construct a priority model for each class of recommended resources;
in response to receiving a request to determine priority of a resource,
determining a class of the classes the resource belongs to, and
using the priority model of the class to compute a priority of the resource; and
executing remedial measures to correct the resource based on the priority, wherein executing remedial measures includes deleting the resource, restarting the resource, and migrating the resource to a different host.

8. The system of claim 7 wherein executing machine learning clustering to classify recommended resources into different classes comprises:
forming a data frame of recommended resources, the data frame including categorical parameters of each recommended resource and categorical variables of dependent resources of each resource; and
encoding the categorical variables into numerical values, the categorical parameters and the encoded categorical variables forming the resource parameters of each recommended resource.

9. The system of claim 7 wherein executing machine learning to construct a priority model for each class of recommended resources comprises:
applying k-means clustering to the categorical parameters and the encoded categorical variables of the resources based on an initial set of cluster centers; and
for each cluster,
testing a cluster for fit to a Gaussian distribution,
replacing cluster center with two child cluster centers when the cluster does not fit a Gaussian distribution, and
applying k-means clustering to the two child cluster centers.

10. The system of claim 7 where executing machine learning to construct a priority model for each class of recommended resources comprises:
for each class of the classes,
partitioning the resource parameters of the resources in the class into training data and validation data;
iteratively computing predictor coefficients of a priority model of the class based on the training data;
computing approximate priorities using the priority model applied to the validation data associated with the class, the approximate priorities approximate the actual priority of the validation data; and
discarding the predictor coefficients when a difference between the approximate priorities and corresponding priorities of the validation data exceeds a threshold.

11. The method of claim 1 wherein determining a class of the classes the resource belongs to comprises:
computing a squared distance between the resource parameters of the resource and resource parameters of each resource of the classes;
determining a minimum squared distance of the squared distances; and
assigning the resource to the class having the minimum squared distance to the resource.

12. The system of claim 7 further comprising:
adding the resource to the class, and
retraining the priority model for the class with the resource added.

13. An operations manager, stored in one or more data-storage devices and executed using one or more processors of a computer system, for identifying and correcting suboptimal resources of a data center, the operations manager comprising:
an analytics engine that executes machine learning clustering to classify recommended resources into different classes according to resource parameters of the recommended resources, executes machine learning to construct a priority model for each class of recommended resources, and in response to receiving a request to determine priority of a resource, determines a class of the classes the resource belongs to, and using the priority model of the class to compute a priority of the resource; and
a remedial measures engine that executes remedial measures to correct the resource based on the priority, wherein executing remedial measures includes deleting the resource, restarting the resource, and migrating the resource to a different host.

14. The operations manager of claim 13 wherein the analytics engine that executes machine learning clustering to classify recommended resources into different classes:
forms a data frame of recommended resources, the data frame including categorical parameters of each recommended resource and categorical variables of dependent resources of each resource; and
encodes the categorical variables into numerical values, the categorical parameters and the encoded categorical variables forming the resource parameters of each recommended resource.

15. The operations manager of claim 13 wherein the analytics engine that executes machine learning to construct a priority model for each class of recommended resources:
applies k-means clustering to the categorical parameters and the encoded categorical variables of the resources based on an initial set of cluster centers; and
for each cluster,
tests a cluster for fit to a Gaussian distribution,
replaces cluster center with two child cluster centers when the cluster does not fit a Gaussian distribution, and
applies k-means clustering to the two child cluster centers.

16. The operations manager of claim 13 where analytics engine that executes machine learning to construct a priority model for each class of recommended resources:
for each class of the classes,
partitions the resource parameters of the resources in the class into training data and validation data;
iteratively computes predictor coefficients of a priority model of the class based on the training data;
computes approximate priorities using the priority model applied to the validation data associated with the class, the approximate priorities approximate the actual priority of the validation data; and
discards the predictor coefficients when a difference between the approximate priorities and corresponding priorities of the validation data exceeds a threshold.

17. The operations manager of claim 13 wherein analytics engine that determines a class of the classes the resource belongs to comprises:
computes a squared distance between the resource parameters of the resource and resource parameters of each resource of the classes;
determines a minimum squared distance of the squared distances; and
assigns the resource to the class having the minimum squared distance to the resource.

18. The operations manager of claim 13 further comprising:
adds the resource to the class, and
retrains the priority model for the class with the resource added.
